(19) United States
(12) Patent Application Publication
(10) Pub. No.: US 2018/0063372 A1
(43) Pub. Date: Mar. 1, 2018

(54) IMAGING DEVICE AND SYSTEM WITH EDGE PROCESSING

(71) Applicant: Elwha LLC, Bellevue, WA (US)

(72) Inventors: Phillip Rutschman, Seattle, WA (US); Ehren Brav, Bainbridge Island, WA (US); Russell Hannigan, Sammamish, WA (US); Roderick A. Hyde, Redmond, WA (US); Muriel Y. Ishikawa, Livermore, CA (US); 3ric Johanson, Seattle, WA (US); Jordin T. Kare, San Jose, CA (US); Tony S. Pan, Bellevue, WA (US); Clarence T. Tegreene, Mercer Island, WA (US); Charles Whitmer, North Bend, WA (US); Lowell L. Wood, Jr., Bellevue, WA (US); Victoria Y.H. Wood, Livermore, CA (US); Travis P. Dorschel, Issaquah, WA (US)

(73) Assignee: Elwha LLC, Bellevue, WA (US)

(21) Appl. No.: 15/697,893

(22) Filed: Sep. 7, 2017

Related U.S. Application Data
(63) Continuation-in-part of application No. 14/838,114, filed on Aug. 27, 2015.
Application No. 14/838,114 is a continuation-in-part of application No. 14/838,128, filed on Aug. 27, 2015.
Application No. 14/838,128 is a continuation-in-part of application No. 14/791,160, filed on Jul. 2, 2015, now Pat. No. 9,866,765.
Application No. 14/791,160 is a continuation-in-part of application No. 14/791,127, filed on Jul. 2, 2015.
Application No. 14/791,127 is a continuation-in-part of application No. 14/714,239, filed on May 15, 2015.
Application No. 14/714,239 is a continuation-in-part of application No. 14/951,348, filed on Nov. 24, 2015, now Pat. No. 9,866,881.
Application No. 14/951,348 is a continuation-in-part of application No. 14/945,342, filed on Nov. 18, 2015.
Application No. 14/945,342 is a continuation-in-part of application No. 14/941,181, filed on Nov. 13, 2015, now abandoned.
(60) Provisional application No. 62/180,040, filed on Jun. 15, 2015.
(60) Provisional application No. 62/156,162, filed on May 1, 2015.
(60) Provisional application No. 62/082,002, filed on Nov. 19, 2014.
(60) Provisional application No. 62/082,001, filed on Nov. 19, 2014.
(60) Provisional application No. 62/081,560, filed on Nov. 18, 2014.
(60) Provisional application No. 62/081,559, filed on Nov. 18, 2014.
(60) Provisional application No. 62/522,493, filed on Jun. 20, 2017.
(60) Provisional application No. 62/532,247, filed on Jul. 13, 2017.
(60) Provisional application No. 62/384,685, filed on Sep. 7, 2016.
(60) Provisional application No. 62/429,302, filed on Dec. 2, 2016.
(60) Provisional application No. 62/537,425, filed on Jul. 26, 2017.

(51) Int. Cl. H04N 1/41; H04N 5/247; H04N 5/232

(52) U.S. Cl. CPC H04N 1/41; H04N 5/23238; H04N 5/247

(57) ABSTRACT

In one embodiment, a device for providing low latency communication of high resolution imagery includes, but is not limited to, a first imaging unit including at least: a first optical arrangement directed at a first field of view; a first image sensor that is positioned with the first optical arrangement and that is configured to convert detected light into first image data; and a first image processor coupled to the first image sensor and configured to execute operations including at least: receive the first image data; process the first image data to generate first output data that requires less bandwidth for communication than the first image data; and transfer the first output data.

### PRIORITY CLAIM

This application claims priority to and/or the benefit of the following patent applications under 35 U.S.C. 119 or 120: U.S. Non-Provisional application Ser. No. 14/838,114 filed Aug. 27, 2015 (Docket No. 1114-003-003-000000); U.S. Non-Provisional application Ser. No. 14/838,128 filed Aug. 27, 2015 (Docket No. 1114-003-007-000000); U.S. Non-Provisional application Ser. No. 14/791,160 filed Jul. 2, 2015 (Docket No. 1114-003-006-000000); U.S. Non-Provisional application Ser. No. 14/791,127 filed Jul. 2, 2015 (Docket No. 1114-003-002-000000); U.S. Non-Provisional application Ser. No. 14/714,239 filed May 15, 2015 (Docket No. 1114-003-001-000000); U.S. Non-Provisional application Ser. No. 14/951,348 filed Nov. 24, 2015 (Docket No. 1114-003-008-000000); U.S. Non-Provisional application Ser. No. 14/945,342 filed Nov. 18, 2015 (Docket No. 1114-003-004-000000); U.S. Non-Provisional application Ser. No. 14/941,181 filed Nov. 13, 2015 (Docket No. 1114-003-009-000000); U.S. Provisional Application 62/180,040 filed Jun. 15, 2015 (Docket No. 1114-003-001-PR0006); U.S. Provisional Application 62/156,162 filed May 1, 2015 (Docket No. 1114-003-005-PR0001); U.S. Provisional Application 62/082,002 filed Nov. 19, 2014 (Docket No. 1114-003-004-PR0001); U.S. Provisional Application 62/082,001 filed Nov. 19, 2014 (Docket No. 1114-003-003-PR0001); U.S. Provisional Application 62/081,560 filed Nov. 18, 2014 (Docket No. 1114-003-002-PR0001); U.S. Provisional Application 62/081,559 filed Nov. 18, 2014 (Docket No. 1114-003-001-PR0001); U.S. Provisional Application 62/522,493 filed Jun. 20, 2017 (Docket No. 1114-003-011-PR0001); U.S. Provisional Application 62/532,247 filed Jul. 13, 2017 (Docket No. 1114-003-012-PR0001); U.S. Provisional Application 62/384,685 filed Sep. 7, 2016 (Docket No. 1114-003-010-PR0001); U.S. Provisional Application 62/429,302 filed Dec. 2, 2016 (Docket No. 1114-003-010-PR0002); and U.S. Provisional Application 62/537,425 filed Jul. 26, 2017 (Docket No. 1114-003-013-PR0001).

The foregoing applications are incorporated by reference in their entirety as if fully set forth herein.

### FIELD OF THE INVENTION

Embodiments disclosed herein relate generally to an imaging device and system with edge processing.

### SUMMARY

In one embodiment, a device for providing low latency communication of high resolution imagery includes, but is not limited to, a first imaging unit including at least: a first optical arrangement directed at a first field of view; a first image sensor that is positioned with the first optical arrangement and that is configured to convert detected light into first image data; and a first image processor coupled to the first image sensor and configured to execute operations including at least: receive the first image data; process the first image data to generate first output data that requires less bandwidth for communication than the first image data; and transfer the first output data.

In another embodiment, a process implemented by a device for providing low latency communication of high resolution imagery includes, but is not limited to, receive first image data from a first image sensor positioned with a first optical arrangement having a first field of view; generate by a first image processor a first output data from the first image data, the first output data requiring less bandwidth for communication than the first image data; and transfer the first output data.

In a further embodiment, a system for providing low latency communication of high resolution imagery includes, but is not limited to, means for receiving first image data from a first image sensor positioned with a first optical arrangement having a first field of view; means for generating by a first image processor a first output data from the first image data, the first output data requiring less bandwidth for communication than the first image data; and means for transferring the first output data.

### BRIEF DESCRIPTION OF THE DRAWINGS

Embodiments are described in detail below with reference to the following drawings:

FIG. 1 is an imaging device with edge processing, in accordance with an embodiment;

FIG. 2 is an imaging device with edge processing, in accordance with an embodiment;

FIGS. 3A-3C are optical arrangements for use in an imaging device with edge processing, in accordance with certain embodiments;

FIG. 4 is a component diagram of an imaging device with edge processing, in accordance with an embodiment;

FIG. 5 is imagery provided by an imaging device with edge processing, in accordance with an embodiment;

FIGS. 6-28 are block diagrams of processes implemented using an imaging device with edge processing, in accordance with various embodiments; and

FIGS. 29-34 are data tables in accordance with various embodiments.

### DETAILED DESCRIPTION

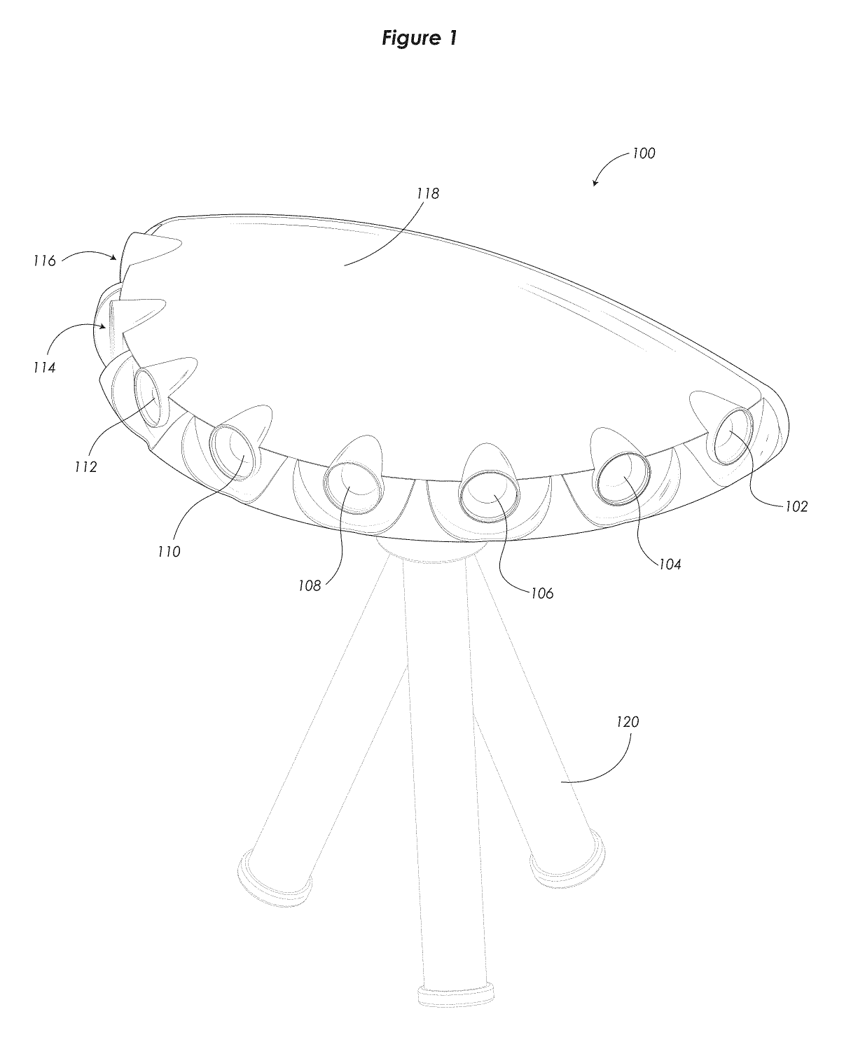

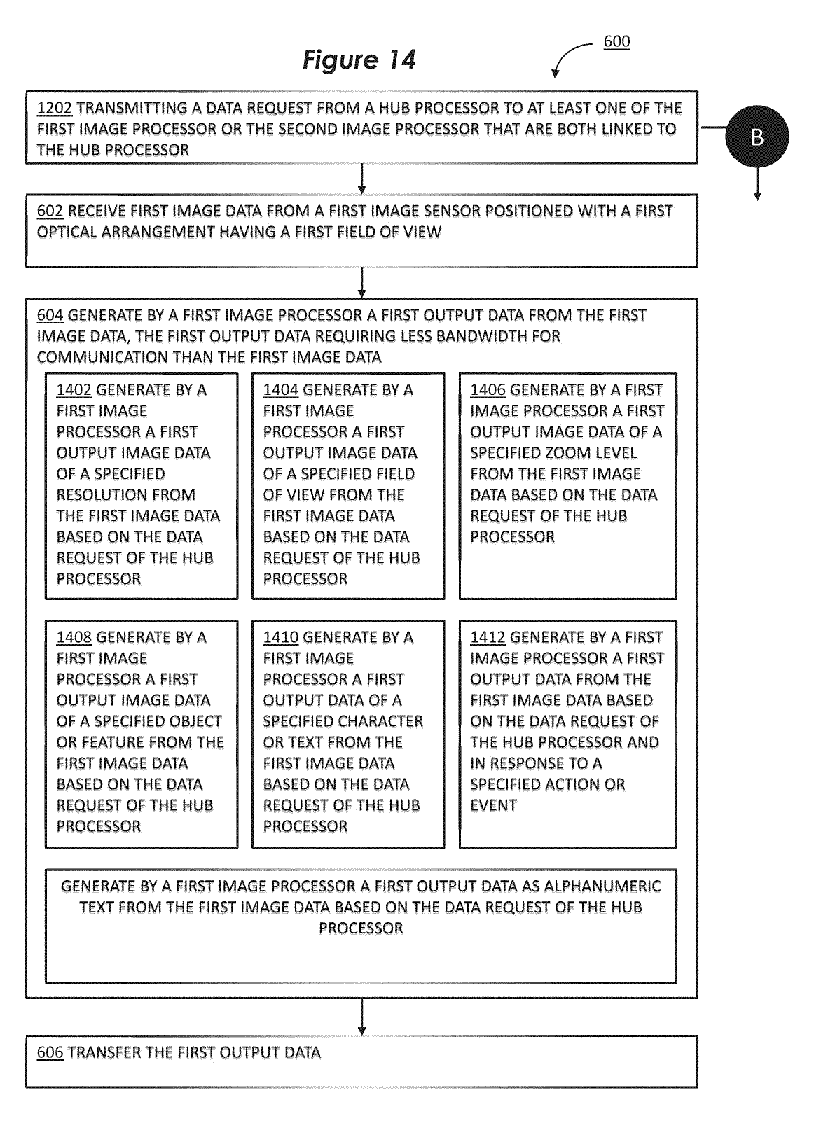

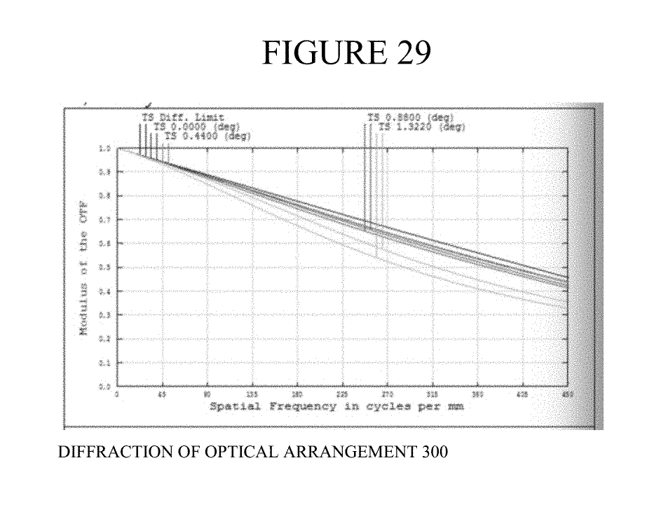

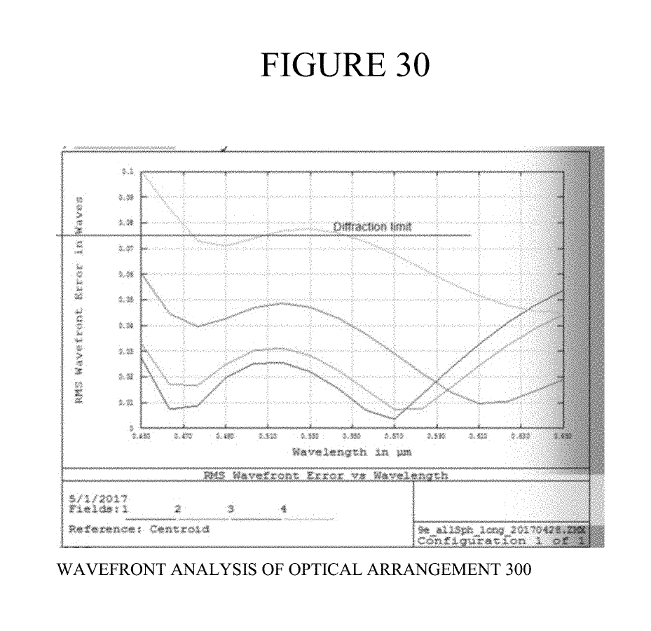

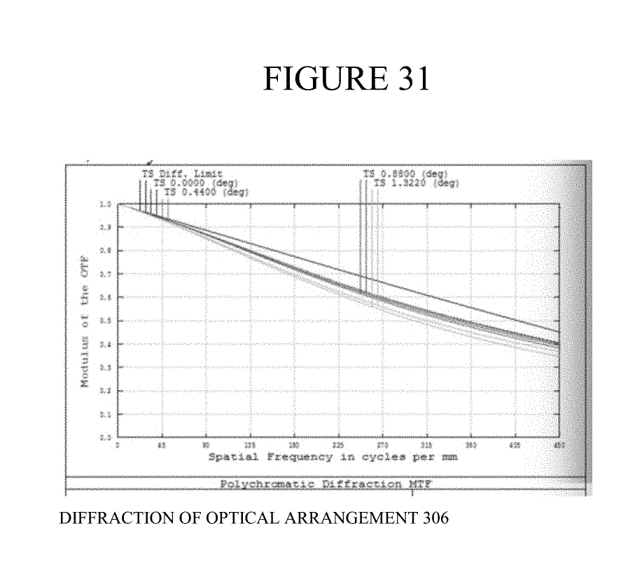

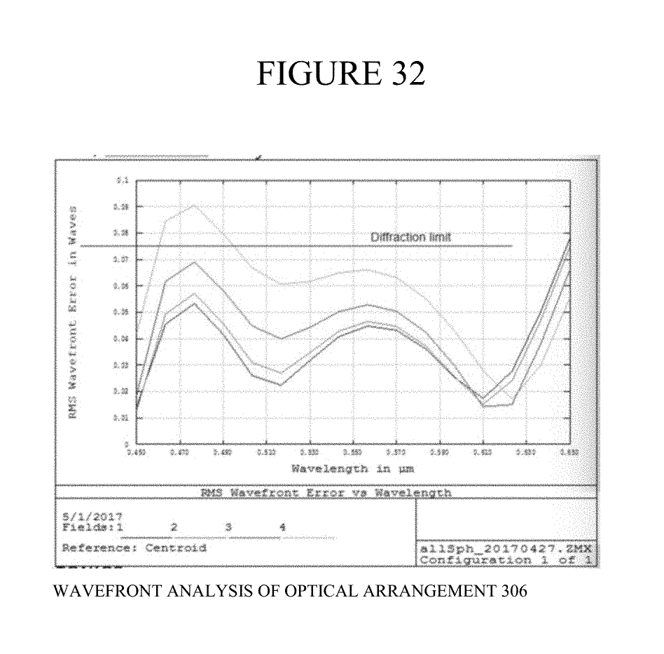

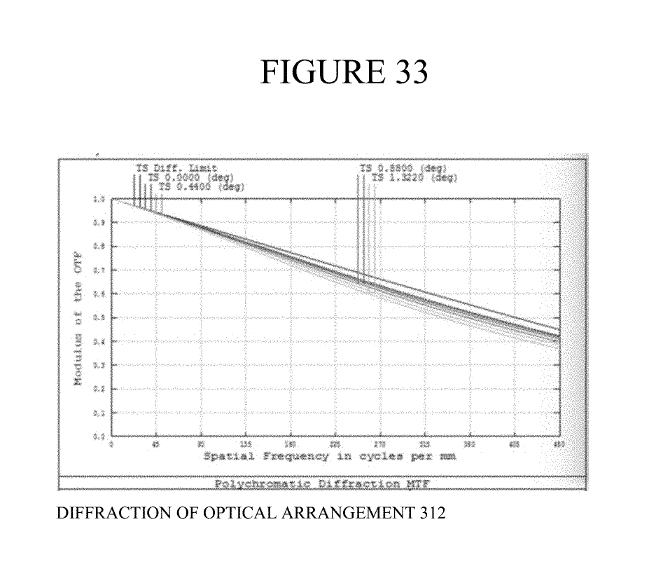

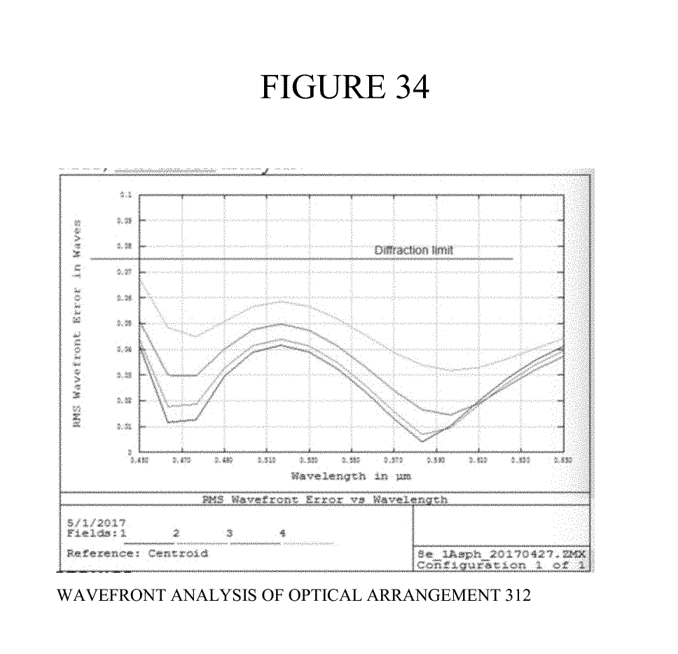

Embodiments disclosed herein relate generally to an imaging device and system with edge processing. Specific details of certain embodiments are set forth in the following description and in FIGS. 1-34 to provide a thorough understanding of such embodiments.

FIG. 1 is an imaging device with edge processing, in accordance with an embodiment.

In one embodiment, a device 100 for providing low latency communication of high resolution imagery includes, but is not limited to, an array of imaging units 102, 104, 106, 108, 110, 112, 114, and 116 contained within a housing 118. The housing 118 includes a support stand 120. Each of the array of imaging units 102, 104, 106, 108, 110, 112, 114, and 116 is directed at a particular field of view.

Housing 118 provides an external protective and/or decorative casing. The housing 118 can be constructed of various materials, including metal, plastic, composite, rubber, ceramic, wood, or a combination of any of the foregoing. Furthermore, the housing 118 can be omitted in full or in part depending upon the application.

The support stand 120 is illustrated as a tripod stand to facilitate placement of the device 100 on a surface, such as a table, floor, roof, ground, or other structure. The support stand 120 can be substituted or complemented with a one, two, four, or more member support. Alternatively, the support stand 120 can be omitted and/or replaced with a clasp, mount bracket, hook, adhesive, straps, ties, or other mechanism for facilitating securing to a wall, ceiling, floor, table, beam, post, or other structure or location.

The array of imaging units 102, 104, 106, 108, 110, 112, 114, and 116 can comprise anywhere from a single imaging unit to hundreds or thousands of imaging units. Any of the imaging units 102, 104, 106, 108, 110, 112, 114, and 116 can be different or identical. For example, any of the imaging units 102, 104, 106, 108, 110, 112, 114, and 116 can include a unique optical arrangement, field of view, image sensor, processor, or other characteristic as discussed herein. The array of imaging units 102, 104, 106, 108, 110, 112, 114, and 116 are depicted as being aligned radially; however, the array of imaging units 102, 104, 106, 108, 110, 112, 114, and 116 can be aligned horizontally, in a grid, spherically, diagonally, circularly, opposingly, and/or a combination of any of the foregoing. In certain embodiments, any of the array of imaging units 102, 104, 106, 108, 110, 112, 114, and 116 can be fixed, movable, or pivotable relative to the housing 118. Therefore, the array of imaging units 102, 104, 106, 108, 110, 112, 114, and 116 can have a constant, fixed, or changeable alignment, such as through mechanical, magnetic, or electromechanical repositioning.

The array of imaging units 102, 104, 106, 108, 110, 112, 114, and 116 are depicted with a combined field of view of approximately one-hundred and eighty degrees with each of the imaging units having an individual field of view of approximately twenty-five degrees. Therefore, in this embodiment, each of the imaging units 102, 104, 106, 108, 110, 112, 114, and 116 has a field of view that at least partially overlaps an adjacent field of view, such as by approximately two to three degrees. However, in certain embodiments, the combined field of view can be greater (e.g., three-hundred and sixty, two-hundred and seventy, three hundred degrees, partially spherical, spherical, etc.) or less (forty-five, ninety, sixty, etc.). Moreover, each of the imaging units 102, 104, 106, 108, 110, 112, 114, and 116 can have more or less overlap in their respective fields of view, such as zero, thirty-five, forty-five, complete, or the like. Alternatively, the imaging units 102, 104, 106, 108, 110, 112, 114, and 116 can be arranged to have their respective fields of view overlap at different positions, such as to a side, above, and/or around one another. Additionally, as discussed, while depicted as fixed, any of the fields of view of the array of imaging units 102, 104, 106, 108, 110, 112, 114, and 116 can be altered, such as through moving, pivoting, sliding, or rotating.

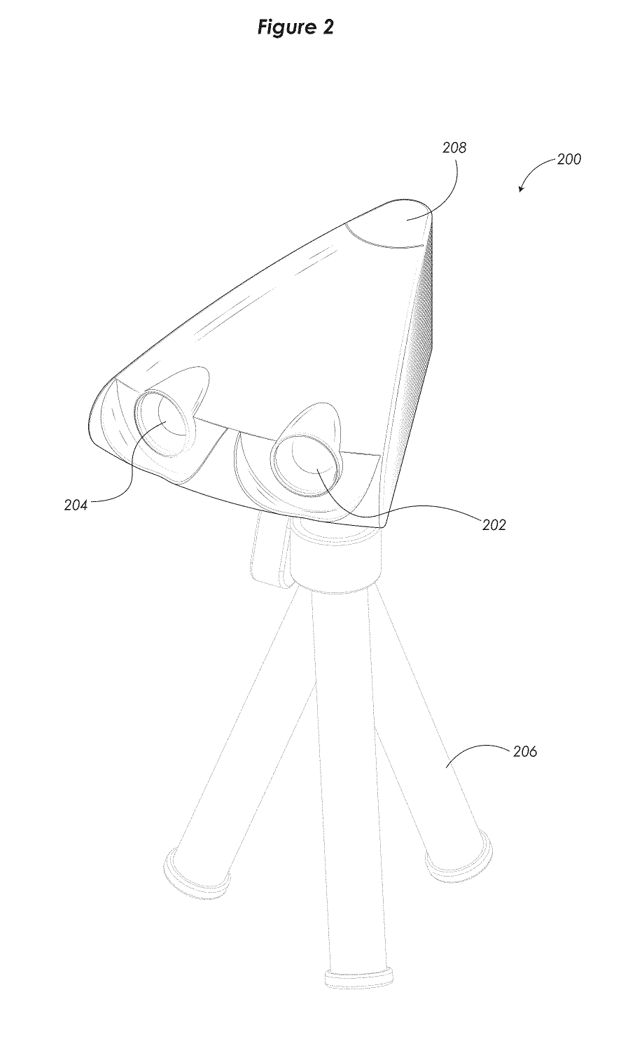

FIG. 2 is an imaging device with edge processing, in accordance with an embodiment.

In one particular embodiment, a device 200 for providing low latency communication of high resolution imagery includes, but is not limited to, an array of imaging units 202, 204 contained within a housing 208. The housing 208 includes a support stand 206. Each of the array of imaging units 202, 204 is directed at a particular field of view of approximately thirty-five degrees with an overlap of approximately five degrees for a combined field of view of approximately sixty degrees. Device 200 can be combined with devices 200 to expand the combined field of view, such as to one-hundred and twenty degrees for two devices 200, one-hundred and eighty degrees for three devices 200, etc.

Housing 208 provides an external protective and/or decorative casing. The housing 208 can be constructed of various materials, including metal, plastic, fiber, composite, rubber, ceramic, wood, or a combination of any of the foregoing. Furthermore, the housing 208 can be omitted in full or in part depending upon the application. In certain embodiments, the housing 208 includes a mechanical and/or electronic interface on at least one side or on both sides for joining another device 200, such as to expand the combined field of view as discussed. When joined in this manner, the device 200 is positioned such that each of the imaging units 202, 204 of the device 200 expand the combined field of view with overlap (e.g. five degrees).

The support stand 206 is illustrated as a tripod stand to facilitate placement of the device 200 on a surface, such as a table, floor, roof, ground, or other structure or support. The support stand 206 can be substituted or complemented with a one, two, four, or more member support. Alternatively, the support stand 206 can be omitted and/or replaced with a clasp, mount bracket, hook, adhesive, straps, ties, or other mechanism for facilitating securing to a wall, ceiling, floor, table, beam, post, or other structure or support.

The array of imaging units 202, 204 can comprise anywhere from a single imaging unit to hundreds or thousands of imaging units. Any of the imaging units 202, 204 can be different or identical. For example, any of the imaging units 202, 204 can include a unique optical arrangement, field of view, image sensor, processor, or other characteristic as discussed herein. The array of imaging units 202, 204 are depicted as being aligned radially; however, the array of imaging units 202, 204 can be aligned horizontally or diagonally. In certain embodiments, any of the array of imaging units 202, 204 can be fixed, movable, or pivotable relative to the housing 208. Therefore, the array of imaging units 202, 204 can have a constant, fixed, or changeable alignment, such as through mechanical or electromechanical repositioning.

The array of imaging units 202, 204 are depicted with a combined field of view of approximately sixty degrees with each of the imaging units 202, 204 having an individual field of view of approximately thirty-five degrees. Therefore, in this embodiment, each of the imaging units 202, 204 has a field of view that at least partially overlaps an adjacent field of view, such as by approximately five degrees. However, in certain embodiments, the combined field of view can be greater (e.g., three-hundred and sixty, two-hundred and seventy, three hundred degrees, one-hundred and eighty, partially spherical, spherical, etc.) or less (forty-five, thirty, etc.). Moreover, each of the imaging units 202, 204 can have more or less overlap in their respective fields of view, such as zero degrees, two degrees, seven degrees, forty-five degrees, complete, or the like. Alternatively, the imaging units 202, 204 can be arranged to have their respective fields of view overlap at different positions, such as to a side, above, and/or around one another. Additionally, as discussed, while depicted as fixed, any of the fields of view of the array of imaging units 202, 204 can be altered, such as through moving, pivoting, sliding, or rotating.

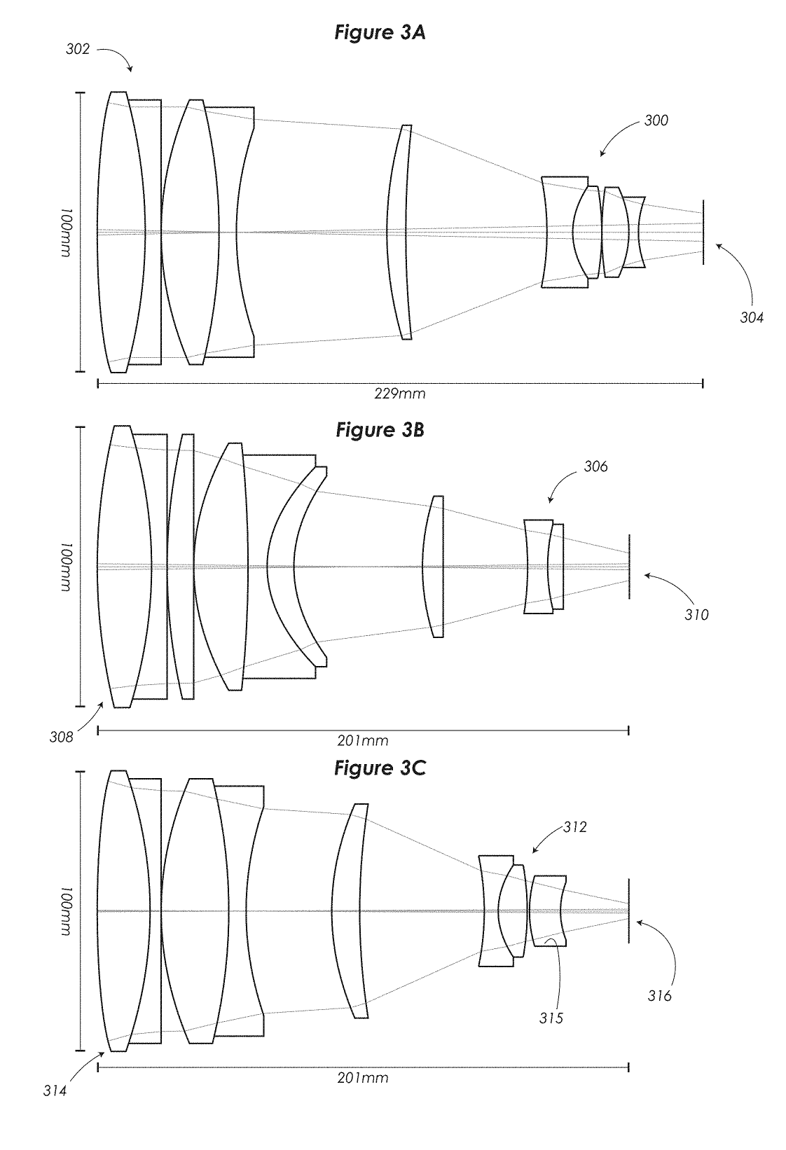

FIGS. 3A-3C are optical arrangements for use in an imaging device with edge processing, in accordance with certain embodiments.

FIG. 3A is an optical arrangement 300 of nine spherical lenses 302 and an image sensor 304. The optical arrangement 300 includes one or more of the following characteristics: a 100 mm input aperture, a 229 mm track, a 165 mm focal length, F1.7, 1.7 kg glass mass, a 2.64 degree full diagonal object space, 7.61 mm full diagonal image, 450 nm-650 nm waveband, anomalous-dispersion glasses, and/or forced-short track for a slightly telephoto configuration. The image sensor 304 can include 5408×4112 pixels.

FIG. 3B is an optical arrangement 306 of nine spherical lenses 308 with one triplet and an image sensor 310. The optical arrangement 306 includes one or more of the following characteristics: a 100 mm input aperture, a 201 mm track, a 165 mm focal length, F1.7, 1.96 kg glass mass, a 2.64 degree full diagonal object space, 7.61 mm full diagonal image, 450 nm-650 nm waveband, anomalous-dispersion glasses, and/or forced-short track for a slightly telephoto configuration. The image sensor 310 can include 5408×4112 pixels.

FIG. 3C is an optical arrangement 312 of seven spherical lenses 314 and one aspherical lens 315 and an image sensor 316. The optical arrangement 312 includes one or more of the following characteristics: a 100 mm input aperture, a 201 mm track, a 165 mm focal length, F1.7, 1.76 kg glass mass, a 2.64 degree full diagonal object space, 7.61 mm full diagonal image, 450 nm-650 nm waveband, anomalous-dispersion glasses, and/or forced-short track for slightly telephoto configurations. The image sensor 316 can include 5408×4112 pixels.

Any of the optical arrangements of FIGS. 3A-3C can be incorporated within the device 100 or the device 200. Alternatively, different optical arrangements can be included within the device 100 or device 200. For example, any of the following lenses are possible as alternatives: lenses with a range of focal length from 135 mm to 200 mm, THEIA 4K, COMPUTAR, OLYMPUS ZUIKO, SONY SONNAR T*, CANON EF, ZEISS SONNAR T*, ZEISS MILVUS, NIKON DC-NIKKOR, NICON AF-S NIKKOR, SIGMA HSM DG ART LENS, ROKINON 135M-N, and/or ROKINON 135M-P.

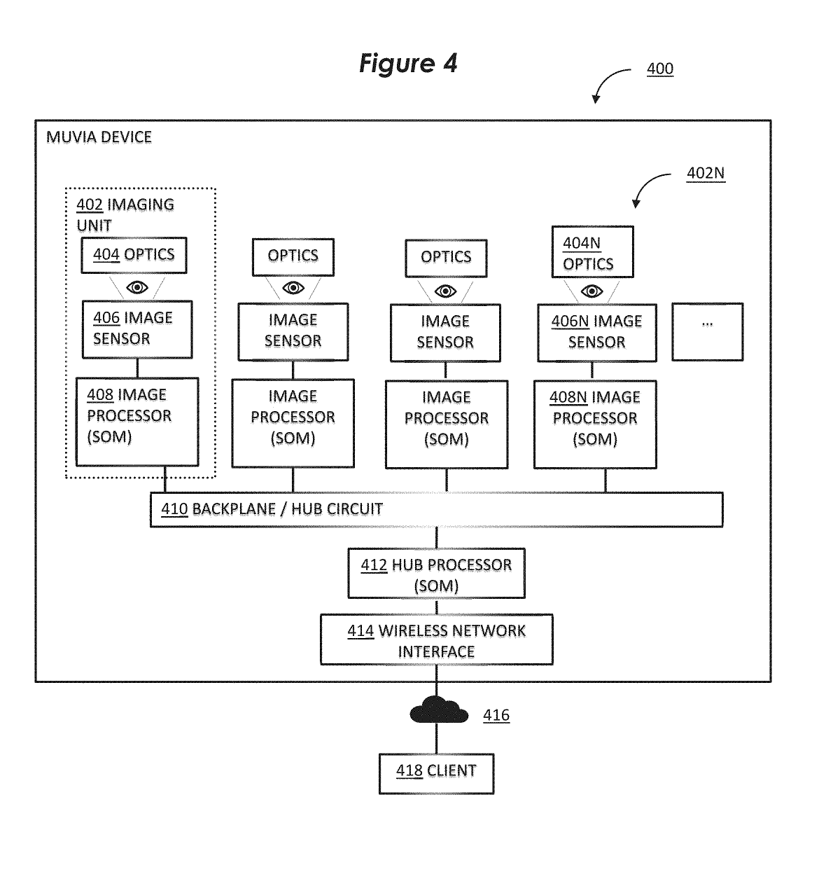

FIG. 4 is a component diagram of an imaging device with edge processing, in accordance with an embodiment.

In one embodiment, imaging device 400 includes an imaging unit 402, a backplane/hub circuit 410, a hub processor 412, and a wireless network interface 414 operable to communicate with a client 418 over a communication link 416. The imaging unit 402 includes optics 404, an image sensor 406, and an image processor 408. The imaging device can include a plurality of the imaging units 402N linked to the hub processor 412 via the backplane/hub circuit 410. The imaging device 400 can assume the form of device 100 or device 200 or another form.

Within the imaging unit 402, the optics 404 are arranged to focus light onto the image sensor 406 as discussed herein. The image sensor 406 is coupled via a high bandwidth link to the image processor 408. The image processor 408 is then coupled via another high bandwidth link to the hub processor 412 via the backplane/hub circuit 410. The hub processor 412 is coupled to the wireless network interface 414 for communication via the communication link 416 having relatively low bandwidth capability.

The optics 404 include any of the optical arrangements discussed herein and are directed at a particular field of view. Imaging units 402N within the imaging device 400 can similarly include optics 404N that are directed toward a different, perhaps overlapping, particular field of view. The optics 404 can be stationary and/or movable, rotatable, pivotable, or slidable.

The image sensor 406 includes a high-pixel-density imager enabling ultra-high resolution imaging. For instance, the image sensor 406 can include an eighteen megapixel sensor that provides around twenty gigabytes per second in image data, has ten thousand pixels per square degree, and provides approximately one to two centimeter resolution from approximately 120 meters distance. One particular example of the image sensor 406 is the SONY IMX 230, which includes 5408 H×4412 V pixels of 1.12 microns. Other imagers with varying resolution are usable and are discussed and illustrated further herein.

The image sensor 406 is communicably linked with the image processor 408 via a high bandwidth communication link. The relatively high bandwidth communication link enables the image processor 408 to have real-time or near-real-time access to the ultra-high resolution imagery output by the image sensor 406 in the tens or hundreds of Gbps range. An example of the high bandwidth communication link includes a MIPI-CSI to LEOPARD/INTRINSYC adaptor that provides data and/or power between the image processor 408 and the image sensor 406.

The image processor 408 is communicably linked with the image sensor 406. Due to the relatively high bandwidth communication link, the image processor 408 has full access to every pixel of the image sensor 406 in real-time or near-real-time. Using this access, the image processor 408 performs an initial pixel reduction prior to communication of any data to the hub processor 412 (e.g., “edge processing”). Pixel reduction operations and functions are disclosed herein, but include, for example, maintaining constant resolution for a field of view, field of view selection, background or object subtraction, overlapping area subtraction, static object subtraction, etc. Other operations in addition to pixel reduction can also be performed by the image processor 408, such as character recognition, feature recognition, event determination, image alteration, compression, or the like as further discussed herein. One particular example of the image processor 408 includes a cellphone-class SOM, such as SNAPDRAGON SOM.

The backplane/hub circuit 410 communicably links the image processor 408 with the hub processor 412. The backplane/hub circuit 410 alternatively communicably links the hub processor 412 with one or more imaging units 402N within the same imaging device 400. The communication link of the backplane/hub circuit 410 provides relatively high bandwidth communication on the order of tens or hundreds of Gbps and can additionally distribute power and ground connections to the image processor 408 and the one or more imaging units 402N. Particular examples of of the backplane/hub circuit include a USB or HDMI hub.

The hub processor 412 is communicably linked to the image processor 408 and the image processors 408N of the imaging units 402N within the same image device 400 via the backplane/hub circuit 410 to leverage and distribute processing load. The relatively high bandwidth communication link of the backplane/hub circuit 410 enables the hub processor 412 to input and output data to the image processor 408 and the image processors 408N in real-time or near-real time. While the hub processor 412 can have access to every pixel the image sensor 406 and the image sensors 406N within the imaging device 400, in certain embodiments the hub processor 412 manages incoming requests and distributes processing load to the image processor 408 and the image processors 406N based on their respective ability and field of view access (e.g., “edge processing”). Functions and operations of the hub processor 412 are discussed further herein, but include, for example, managing, triaging, delegating, coordinating, and/or satisfying incoming user request for image data using the image processor 408 and the image processors 406N within the imaging device 400. Other example operations or functions of the hub processor 412 include obtaining reduced image data from the image processor 408 and the image processors 406N and stitching, compressing, and/or 3D rendering the obtained image data prior to transmission. One particular example of the hub processor 412 includes a cellphone-class SOM, such as the SNAPDRAGON SOM.

The wireless network interface 414 provides a relatively low bandwidth communication interface between the hub processor 412 and the communication link 416 on the order of one Mbps. While the wireless network interface 414 may provide the highest wireless bandwidth available or feasible, such bandwidth is relatively low as compared to the relatively high bandwidth communication between the image sensor 406, the image processor 408, the backplane/hub circuit 410, and the hub processor 412, and the imaging units 402N within the imaging device 400. Thus, the hub processor 412 does not necessarily transmit all available pixel data from the imaging unit 402 and the imaging units 402N within the imaging device 400 via the wireless network interface 414, but instead uses edge processing distributed on-board the imaging device 400 to enable collection of the very high resolution imagery and selection/reduction of that imagery for transmission via the wireless network interface 414 to satisfy that which is requested (e.g., constant resolution for a particular requested field of view or zoom level). The wireless network interface 414 can, in certain embodiments, be substituted with a wire-based network interface, such as ethernet, USB, and/or HDMI. One particular example of the wireless network interface 414 includes a cellular, WIFI, BLUETOOTH, satellite network, radio broadcast, and/or websocket enabling communication over the communication link 416 of the internet with the client 418 running JAVASCRIPT, HTML5, CANVAS GPU, and WEBGL.

For example, in one embodiment that demonstrates operation, the imaging device 400 includes an array of imaging units 402, each including optics 404, an image sensor 406, and an image processor 408. The array of imaging units 402 collect ultra-high resolution imagery of different fields of view that together establish an ultra-high-resolution overall scene that far exceeds the bandwidth capability of the wireless network interface 414. The hub processor 412 manages an incoming request for a field of view and zoom level and triages that request to a selection of the image processors 408 of the array of imaging units 402 that have access to the requested field of view and zoom level. The respective image processors 408 decimate pixels other than the selected field of view and zoom level and reduce the resolution of the remaining pixels to maintain a specified constant resolution (e.g., the maximum screen resolution of a requesting user device). The remaining pixels are returned to the hub processor 412 for stitching together (e.g., in the event that the pixels span multiple fields of view from different imaging units 402) and/or compression. The hub processor 412 then responds to the request with the image data, which is of a high resolution for the particular requesting user device, which satisfies the request, and which fits within the bandwidth constraints of the wireless network interface 414 and/or communication link 416.

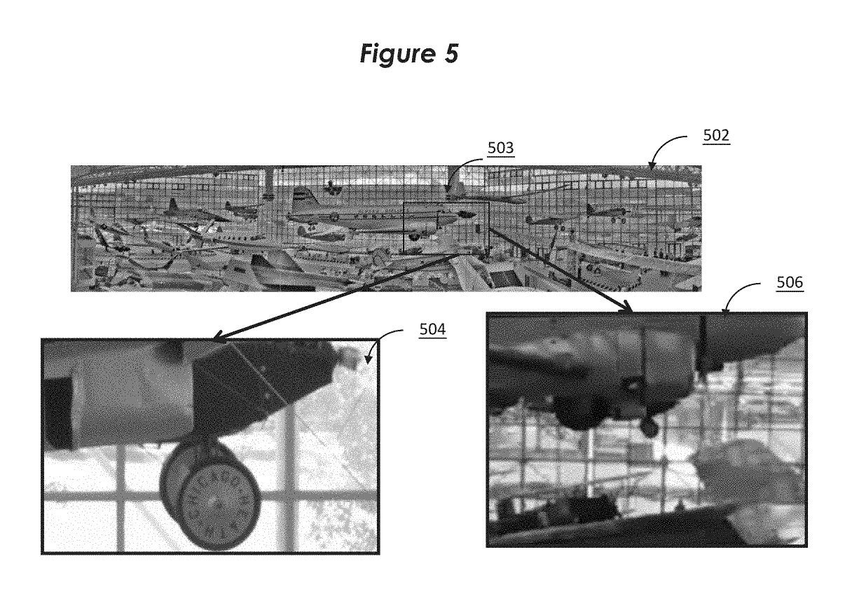

FIG. 5 is imagery provided by an imaging device with edge processing, in accordance with an embodiment.

In this particular example, the imaging device 400 captures and provides the image data 502 to a user device. The image data 502 includes a view of within the BOEING FLIGHT MUSEUM, including multiple airplanes on display. The resolution of the image data 502 provided to the user device is that of the display resolution of the user device (e.g., 750×1334 pixels). In response to a further request of the user device for a zoom to the area 503 within the image data 502, the imaging device 400 provides the image data of 504, also having the resolution of the user device (e.g., 750×1334 pixels). As can be seen, the image data of 504 includes a level of acuity not possible using typical cameras or webcams, which is represented by the image data 506. That is, the image data 504 provided by the imaging device 400 includes sufficient detail to resolve the text on a wheel of the aircraft in the area 503 of the image data 502. Contrast this with the maximum zoom level provided by a typical camera or webcam in the image data of 504 where the wheel remains a dark granular object. Despite the extreme differences in acuity between the image data of 504 and the image data of 506, the bandwidth requirements for each transmission are approximately equal. The processes and operations to achieve this result are enabled by the devices, optics, components, and operations that are described and illustrated herein. For example, the imaging device 400 captures and has access to more pixels than are transmitted with respect to the image data 502; the image data 502 is the result of pixel decimation by the imaging device 400 prior to transmission of pixels that are not needed to provide the resolution at the depicted field of view and zoom level. The image data 504 has the same or similar resolution as that of the image data 502 due to the imaging device 400 decimating fewer or none of the available pixels for the depicted field of view and zoom level. Thus, in this example, the imaging device 400 processes the full resolution imagery on-board to maintain a substantially constant resolution through adjustable pixel decimation prior to transmission to the user device, the resolution being defined in certain embodiments by the screen resolution of the user device for a selected zoom level and field of view. Many other processes and operations of the imaging device 400 are discussed herein.

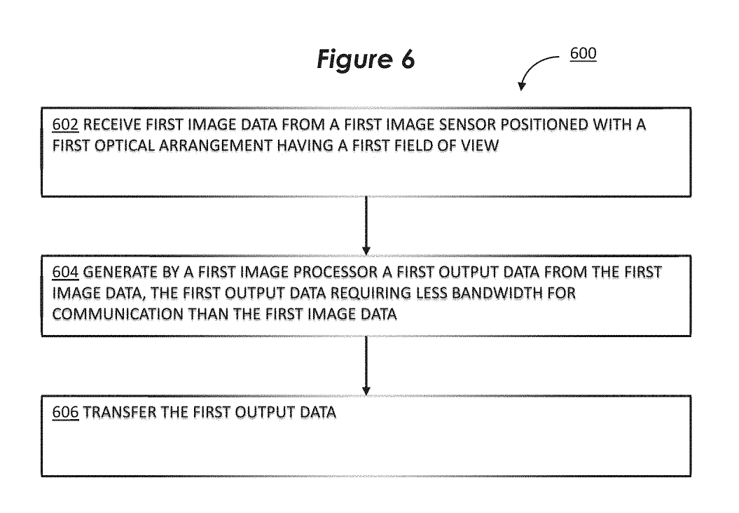

FIG. 6 is a block diagram of a process 600 implemented using an imaging device 400 with edge processing for providing low latency communication of high resolution imagery. In one embodiment, the process 600 includes, but is not limited to, receive first image data from a first image sensor positioned with a first optical arrangement having a first field of view at 602; generate by a first image processor a first output data from the first image data, the first output data requiring less bandwidth for communication than the first image data at 604; and transfer the first output data at 606.

For example, the image sensor 406 can produce ultra-high resolution image data of a scene obtained using the optics 404. The image processor 408 can process the ultra-high resolution image data to select image data of a specified field of view and zoom level within the scene, decimate non-selected image data, and decimate pixels of the selected image data to maintain a constant resolution independent of the specified field of view and zoom level. The image processor 408 can then pass the selected and decimated image data to the hub processor 412 for processing prior to communication to a requesting device. In this manner, the image processor 408 selects an area and zoom level and maintains that selection at a specified resolution through adjustable pixel decimation. The specified resolution may be based, for example, on the maximum resolution that a requesting device can display. Thus, the specified resolution, while possibly reduced from what is available from the image sensor 406 remains high for a requesting device independent of a zoom level and field of view selection. Moreover, the response latency for the high resolution image data is very low at least in part due to the image processor 408 decimating non-requested image data and decimating excess pixels within the requested image data. Many other additional or alternative operations and processes are discussed herein.

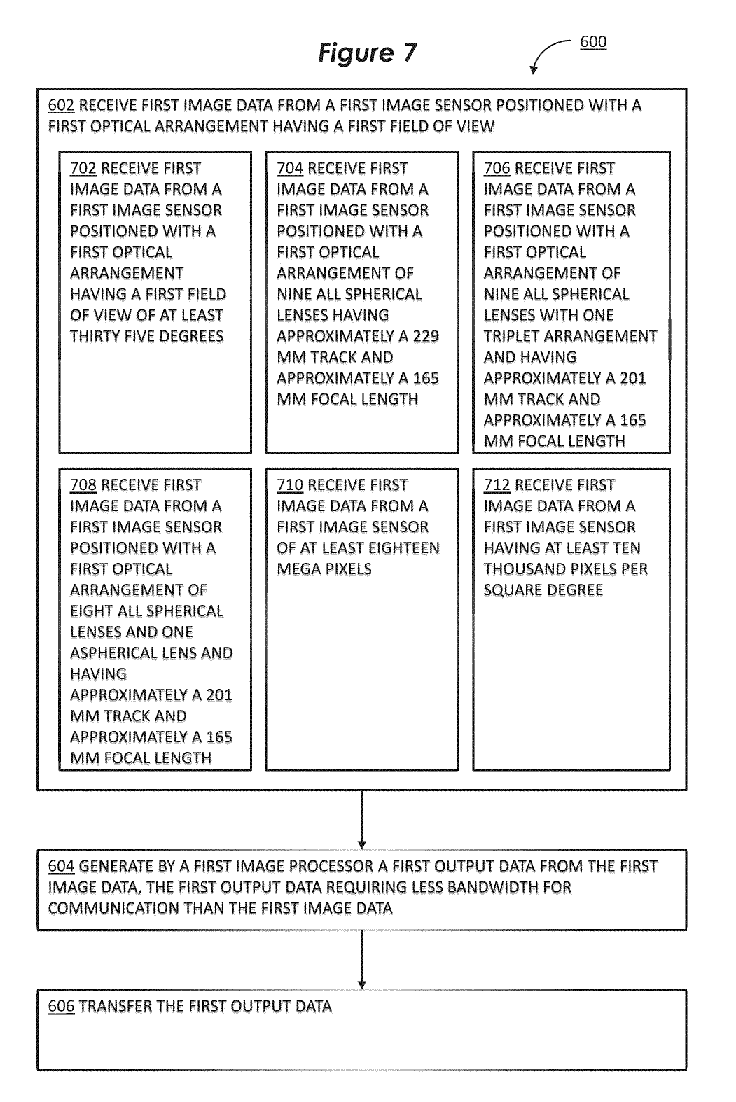

FIG. 7 is a block diagram of a process 600 implemented using an imaging device 400 with edge processing for providing low latency communication of high resolution imagery. In one embodiment, the receive first image data from a first image sensor positioned with a first optical arrangement having a first field of view at 602 includes one or more of receive first image data from a first image sensor positioned with a first optical arrangement having a first field of view of at least thirty five degrees at 702; receive first image data from a first image sensor positioned with a first optical arrangement of nine all spherical lenses having approximately a 229 mm track and approximately a 165 mm focal length at 704; receive first image data from a first image sensor positioned with a first optical arrangement of nine all spherical lenses with one triplet arrangement and having approximately a 201 mm track and approximately a 165 mm focal length at 706; receive first image data from a first image sensor positioned with a first optical arrangement of eight all spherical lenses and one aspherical lens and having approximately a 201 mm track and approximately a 165 mm focal length at 708; receive first image data from a first image sensor of at least eighteen mega pixels at 710; or receive first image data from a first image sensor having at least ten thousand pixels per square degree at 712.

In one embodiment, the image processor 408 receives first image data from a first image sensor 406 positioned with a first optical arrangement 404 having a first field of view of at least thirty five degrees at 702. The relatively small field of view enables capture by the image sensor 406 of ultra-high resolution imagery for a subset of the scene. Imaging units 402N of the imaging device 400 can similarly obtain ultra-high resolution image data for portions of the scene. The field of view of the optical arrangement 404 can be modified, increased, decreased, or changed based on a particular application. For instance, the field of view can be anywhere from approximately one to one-hundred and eighty degrees. The field of view can also extend in the Z-axis anywhere from one to one hundred and eighty degrees. It is also possible to provide a field of view of up to three-hundred and sixty degrees and also include a partial or complete spherical field of view.

In one embodiment, the image processor 408 receives first image data from a first image sensor 406 positioned with a first optical arrangement 404 of nine all spherical lenses having approximately a 229 mm track and approximately a 165 mm focal length at 704. In another embodiment, the image processor 408 receives first image data from a first image sensor 406 positioned with a first optical arrangement 404 of nine all spherical lenses with one triplet arrangement and having approximately a 201 mm track and approximately a 165 mm focal length at 706. In a further embodiment, the image processor 408 receives first image data from a first image sensor 406 positioned with a first optical arrangement 402 of eight all spherical lenses and one aspherical lens and having approximately a 201 mm track and approximately a 165 mm focal length at 708. In these embodiments, the optical arrangement 404 of of the imaging unit 402 of the imaging device 400 can be identical or different with optical arrangements of the one or more imaging units 402N of the imaging device 400. For instance, the optical arrangement 404 can be a spot imager type optical arrangement configured for highly focused applications, whereas one or more other optical arrangements of the imaging device 400 can be a global imager type optical arrangement configured for wider fields of view. Moreover, the optical arrangement 404 can be modified or changed to any optical arrangement depending upon a particular application. Examples of the optical arrangement 404 include any of the following lenses: lenses with a range of focal length from 135 mm to 200 mm, THETA 4K, COMPUTAR, OLYMPUS ZUIKO, SONY SONNAR T*, CANON EF, ZEISS SONNAR T*, ZEISS MILVUS, NIKON DC-NIKKOR, NICON AF-S NIKKOR, SIGMA HSM DG ART LENS, ROKINON 135M-N, and/or ROKINON 135M-P.

In one embodiment, the image processor 408 receives first image data from a first image sensor 406 of at least eighteen mega pixels at 710. The first image sensor 406 in this example includes a very large number of pixels for a relatively small field of view. Image sensors 406N of imaging units 402N within the imaging device 400 similarly may be of at least eighteen mega pixels each for relatively small fields of view. Together, the image sensor 406 combined with image sensors 406N of the imaging device 400 provide for an extremely large number of combined pixels over a scene (e.g., 18 megapixels×N number of image sensors of the imaging device 400). In other embodiments, the image sensor 406 has fewer or greater amounts of pixels, for example anywhere from a few mega pixels to tens or hundreds of megapixels as available and/or needed for a particular application. Alternatively, in some embodiments, the image sensor 406 is identical or different as compared to image sensors 406N of the imaging device 400.

In one embodiment, the image processor 408 receives first image data from a first image sensor 406 having at least ten thousand pixels per square degree at 712. An image sensor 406 with approximately ten thousand pixels per square degree provides very high resolution imagery. The number of pixels per square degree can be less or more depending upon the particular application, such as anywhere from approximately one or two thousand pixels per square degree to tens or hundreds of thousands of pixels per square degree as available or needed. Image sensors 406N of the imaging device 400 can similarly include approximately ten thousand pixels per square degree or can be modified based on different purposes of the imaging units 402N of the imaging device 400 (e.g., spot imagers vs. global imagers can have different pixel densities within the same imaging device 400).

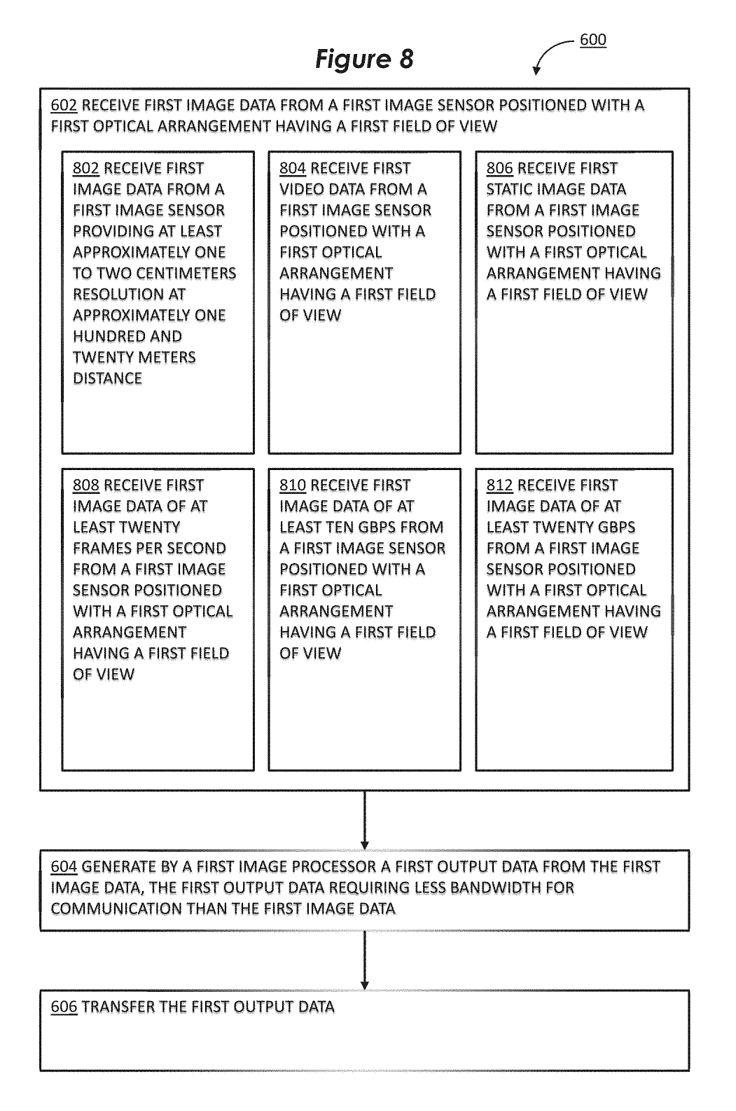

FIG. 8 is a block diagram of a process 600 implemented using an imaging device 400 with edge processing for providing low latency communication of high resolution imagery. In one embodiment, the receive first image data from a first image sensor positioned with a first optical arrangement having a first field of view at 602 includes one or more of receive first image data from a first image sensor providing at least approximately one to two centimeters acuity at approximately one hundred and twenty meters distance at 802; receive first video data from a first image sensor positioned with a first optical arrangement having a first field of view at 804; receive first static image data from a first image sensor positioned with a first optical arrangement having a first field of view at 806; receive first image data of at least twenty frames per second from a first image sensor positioned with a first optical arrangement having a first field of view at 808; receive first image data of at least ten Gbps from a first image sensor positioned with a first optical arrangement having a first field of view at 810; or receive first image data of at least twenty Gbps from a first image sensor positioned with a first optical arrangement having a first field of view at 812.

In one embodiment, the image processor 408 receives first image data from a first image sensor 406 providing at least approximately one to two centimeters resolution at approximately one hundred and twenty meters distance at 802. In other words, the first image sensor 406 captures sufficient image data from a distance of over a hundred meters that enables approximately one to two centimeter effective acuity. For example, a title on a book, a license plate number, or keys can be easily read and/or identified from a distance of over a hundred meters using the image data obtained from the image sensor 406. In certain cases, the optics 404 move or change focus to increase zoom to this particular level. However, in the example described here, the optics 404 do not move or change focus, but rather the zoom and/or focus change are handled by the processor 408 through pixel selection and pixel decimation. In certain embodiments, the image sensor 406 can provide more or less visual acuity such as anywhere from one centimeter to ten or thirty meters from a distance of approximately one-hundred meters. In some embodiments, the image sensors 406N of the imaging device 400 can include similar or different acuity capabilities depending upon the particular application.

In one embodiment, the processor 408 receives first video data from a first image sensor 406 positioned with a first optical arrangement 404 having a first field of view at 804. In another embodiment, the processor 408 receives first static image data from a first image sensor 406 positioned with a first optical arrangement 404 having a first field of view at 806. The first image sensor 406 captures image data, which can be retained as static imagery or a collection of frames of static imagery (e.g., video) by the processor 408. The static imagery can include a picture of a person, object, or event. The video data can include moving imagery of a person, object, or event. In one particular embodiment, the processor 408 can switch between collection of static or video image data based upon one or more parameters, such as a detected event or occurrence, a program request, or a user request. Alternatively, the processor 408 can be dedicated to collection of either static or video imagery. In certain cases, the image processors 408N of the imaging device 400 are configured to collect the same type of imagery as the processor 408 or a different type of imagery as the processor 408.

In one embodiment, the processor 408 receives first image data of at least twenty frames per second from a first image sensor 406 positioned with a first optical arrangement 404 having a first field of view at 808. Twenty frames per second is a frequency sufficient to provide the perception of motion. However, in certain embodiments, the processor 408 can capture the image data at fewer or greater frames per second, such as between approximately three to thirty or more frames per second, processors 408N of the imaging device 400 can capture image data at a similar, different, or varying rate depending upon the particular application.

In one embodiment, the image processor 408 receives first image data of at least ten Gbps from a first image sensor 406 positioned with a first optical arrangement 404 having a first field of view at 810. In another embodiment, the image processor 408 receives first image data of at least twenty Gbps from a first image sensor 406 positioned with a first optical arrangement 404 having a first field of view at 812. The image data amount is a function of the total number of pixels and capture rate over time. In these examples, the image data includes a very high amount relative to a bandwidth availability of the wireless network interface 414 or the communication link 416. For example, the image data from just one of the imaging units 402 (e.g., ten Gbps) can far outstrip available communication bandwidth of the wireless network interface 414 (one to hundreds of Mbps). Each of the imaging units 402N of the imaging device 400 may similarly capture image data at a rate of approximately ten or twenty Gbps for a cumulative image data amount that even further exceeds the bandwidth availability of the wireless network interface 414 (e.g., twenty Gbps×N number of imaging units vs. approximately one to hundreds of Mbps in available bandwidth).

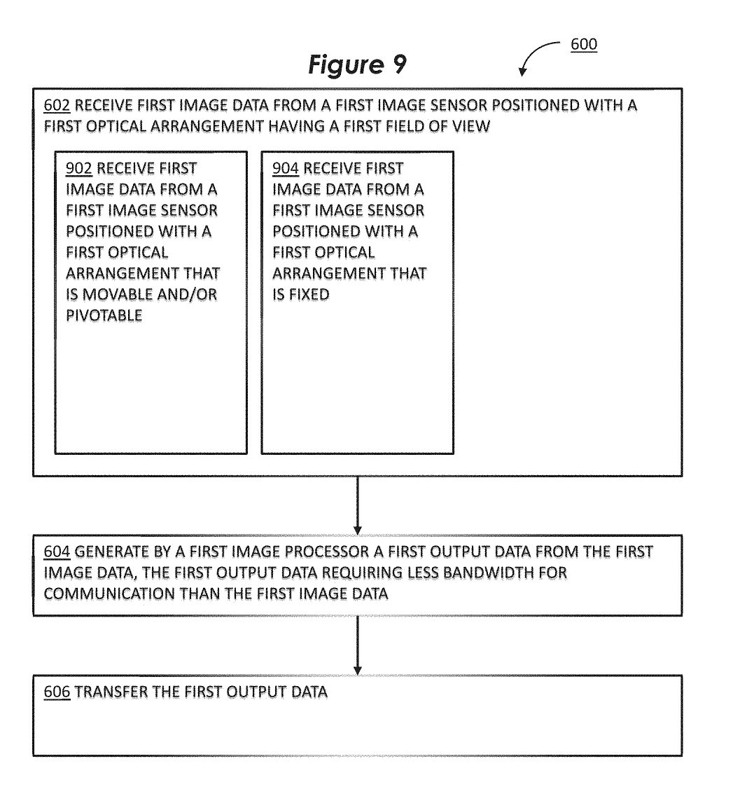

FIG. 9 is a block diagram of a process 600 implemented using an imaging device 400 with edge processing for providing low latency communication of high resolution imagery. In one embodiment, the receive first image data from a first image sensor positioned with a first optical arrangement having a first field of view at 602 includes one or more of receive first image data from a first image sensor positioned with a first optical arrangement that is movable and/or pivotable at 902; and receive first image data from a first image sensor positioned with a first optical arrangement that is fixed at 904.

In one embodiment, the image processor 408 receives first image data from a first image sensor 406 positioned with a first optical arrangement 404 that is movable and/or pivotable at 902. The imaging unit 404 and/or the optics 404 can be mounted on a track, hinge, gimbal, pivot, robotic arm, or other movable mechanism to enable movement and changes in the field of view. Movement may be controlled manually, such as through physical application of force, or automatically, such as through electromechanical motors that are controlled by a computer program or a user. In certain embodiments, any of the imaging units 402N or optical arrangements 404N of the imaging device 400 can similarly be mounted for movement or pivoting, either in unison or independently of one another.

In one embodiment, the image processor 408 receives first image data from a first image sensor 406 positioned with a first optical arrangement 404 that is fixed at 904. Fixing of the first image sensor 406 or the optics 404 may be relative to a housing or relative to the imaging device 400 or relative to a structure. For instance, a housing may be moved, but the first image sensor 406 and/or the optics 404 are fixed and do not move relative to the housing. While the optics 404 are fixed and capture a set field of view, it is still possible for the image processor 408 to digitally recreate the effects of movement and/or zooming within the field of view of the optics 404. The processor 408 accomplishes this through pixel selection and/or pixel decimation. In certain embodiments, any of the imaging units 402N of the imaging device 400 are fixed. However, in some embodiments, any of the optics 404N or imaging units 402N within the imaging device 400 can be independently movable or pivotable, such as to have a blend of fixed and movable imaging units within the imaging device 400.

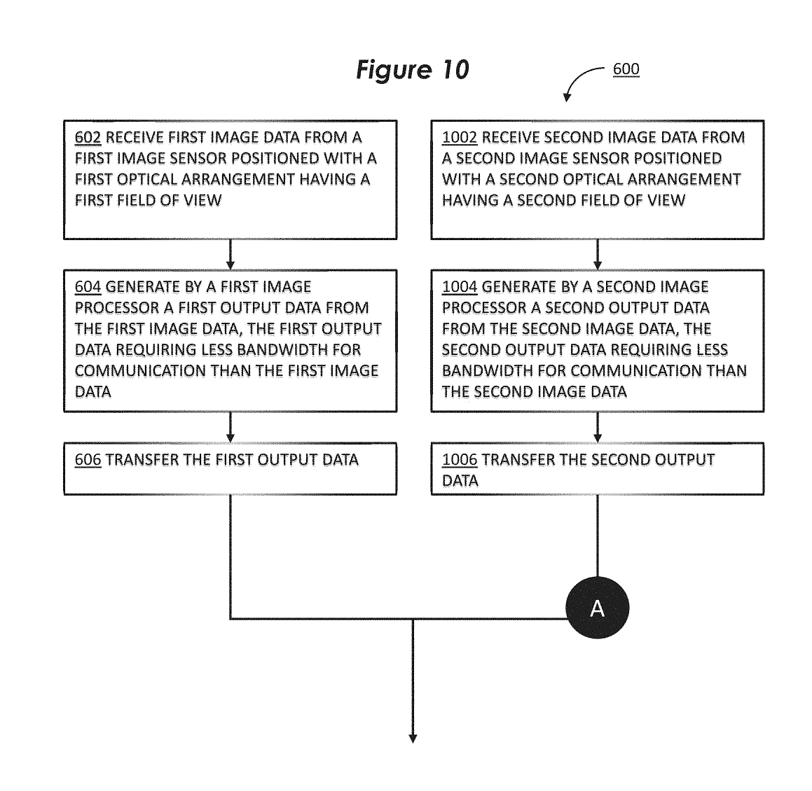

FIG. 10 is a block diagram of a process 600 implemented using an imaging device 400 with edge processing for providing low latency communication of high resolution imagery. In one embodiment, process 600 further includes operations performed by at least one imaging unit 402N of the imaging device 400. The image processor 408 receives second image data from a second image sensor 406N positioned with a second optical arrangement 404N having a second field of view at 1002; generates a second output data from the second image data, the second output data requiring less bandwidth for communication than the second image data at 1004; and transfers the second output data at 1006. The imaging device 400 can include one or two or more imaging units 402N as an array of imaging units. In some instances, the imaging device 400 includes only the imaging unit 402 and in other instances, the imaging device 400 includes a multitude of the imaging units 402N. The imaging units 402N are linked with the imaging unit 402 to the hub processor 412 via the backplane/hub circuit 410. Each of the imaging units 402N can perform any of the operations or functions described and illustrated with respect to the imaging unit 402.

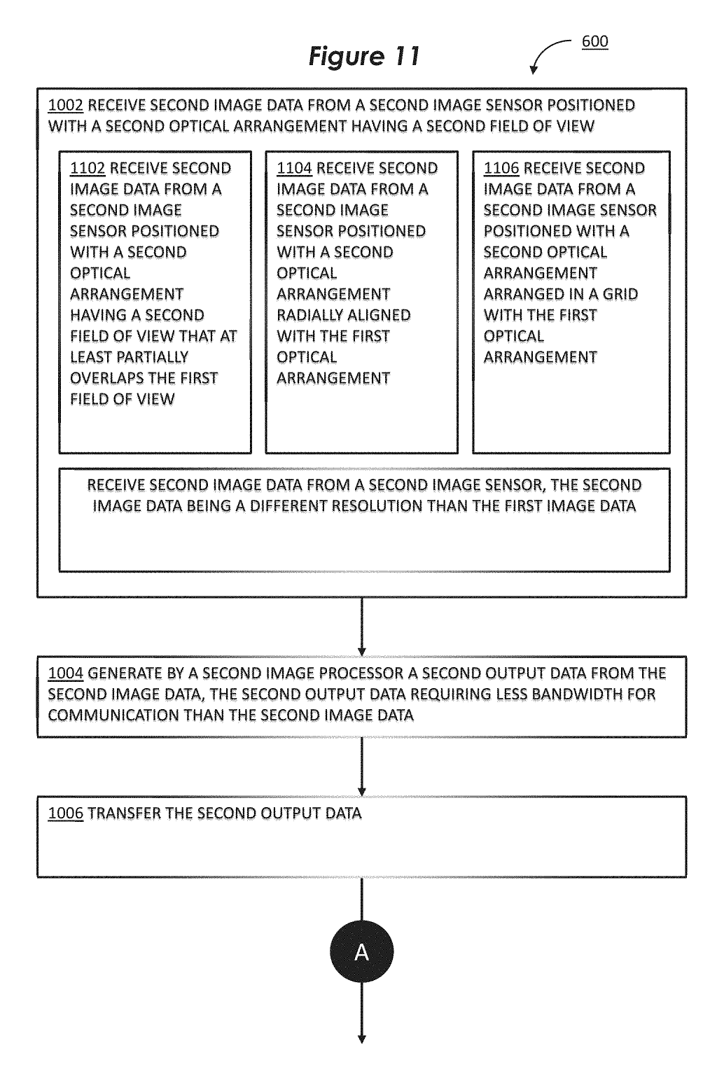

FIG. 11 is a block diagram of a process 600 implemented using an imaging device 400 with edge processing for providing low latency communication of high resolution imagery. In one embodiment, the receive second image data from a second image sensor positioned with a second optical arrangement having a second field of view at 1002 includes one or more of receive second image data from a second image sensor positioned with a second optical arrangement having a second field of view that at least partially overlaps the first field of view at 1102; receive second image data from a second image sensor positioned with a second optical arrangement radially aligned with the first optical arrangement at 1104; or receive second image data from a second image sensor positioned with a second optical arrangement arranged in a grid with the first optical arrangement at 1106.

In one embodiment, the image processor 408N receives second image data from a second image sensor 406N positioned with a second optical arrangement 404N having a second field of view that at least partially overlaps the first field of view at 1102. For example, the first optics 404 are arranged adjacent with the second optics 404N such that each has approximately a thirty-five degree field of view. Together the first optics 404 and the second optics 404N cover a combined sixty or more degree field of view with approximately a five degree field of view overlap therebetween. The image sensor 406 therefore captures image data associated with the first optics 404 field of view and the image sensor 406N captures image data associated with the second optics 404N field of view. The image processor 408 has access to the image data of the image sensor 406 and the image processor 408N has access to the image data of the image sensor 406N. The image processor 408 does not have direct access to the image data of the image sensor 406N and the image processor 408N does not have direct access to the image data of the image sensor 406, but in certain embodiments this can be permitted. The field of view overlap between the optics 404 and the optics 404N, however, enable each of the image processor 408 and the image processor 408N to have access to at least some of the same image data. The amount of field of view overlap between the first optics 404 and the optics 404N can vary from none to one degree to ten degrees to twenty or more degrees depending upon application. Moreover, in certain embodiments, the imaging unit 402 and/or the imaging unit 404 can adjust the field of view overlap through mechanical or digital adjustments.

In one embodiment, the processor 408N receives second image data from a second image sensor 406N positioned with a second optical arrangement 404N radially aligned with the first optical arrangement 404 at 1104. The radial alignment of the optical arrangement 404 and the optical arrangement 404N is illustrated in FIGS. 1 AND 2. In certain embodiments, radial alignment can include the optical arrangement 404 and the optical arrangement 404N being in a common horizontal plane or being offset or staggered. In other embodiments, radial alignment of the optical arrangement 404 and the optical arrangement 404N can include adjacent alignment along a line. In further embodiments, radial alignment of the optical arrangement 404 and the optical arrangement 404N can include non-adjacent alignment, such as where optical arrangement 404 is directed to one field of view and the optical arrangement 404N is directed to an opposing field of view (e.g., ninety, one-hundred and eighty, or two-hundred and seventy degrees offset). Alternatively, in certain embodiments, radial alignment can include spherical or partial spherical alignment.

In one embodiment, the image processor 408N receives second image data from a second image sensor 406N positioned with a second optical arrangement 404N arranged in a grid with the first optical arrangement 404 at 1106. The grid can include a side-by-side, diagonal, a horizontal, a vertical, or a block arrangement of the first optics 404 and the optics 402N. For example, the imaging unit 402 can be arranged with eight imaging units 402N in three rows of three within a common vertical plane. In this example, each of the imaging units 402 and 402N can be parallel aligned, or the group can be slightly parabolic, concave, convex, aspherical, spherical, or curved. The imaging units 402 and 402N can also have slightly overlapping field of views (e.g., annular or tile-like). In certain embodiments, the imaging units 402 and 402N can be identical or different, such as by way of the optics, imager, or processor capabilities and/or configurations. In one particular embodiment, the imaging units 402 and 402N include at least some global type imaging units having a wide field of view combined with at least some spot type imaging units have a narrow field of view.

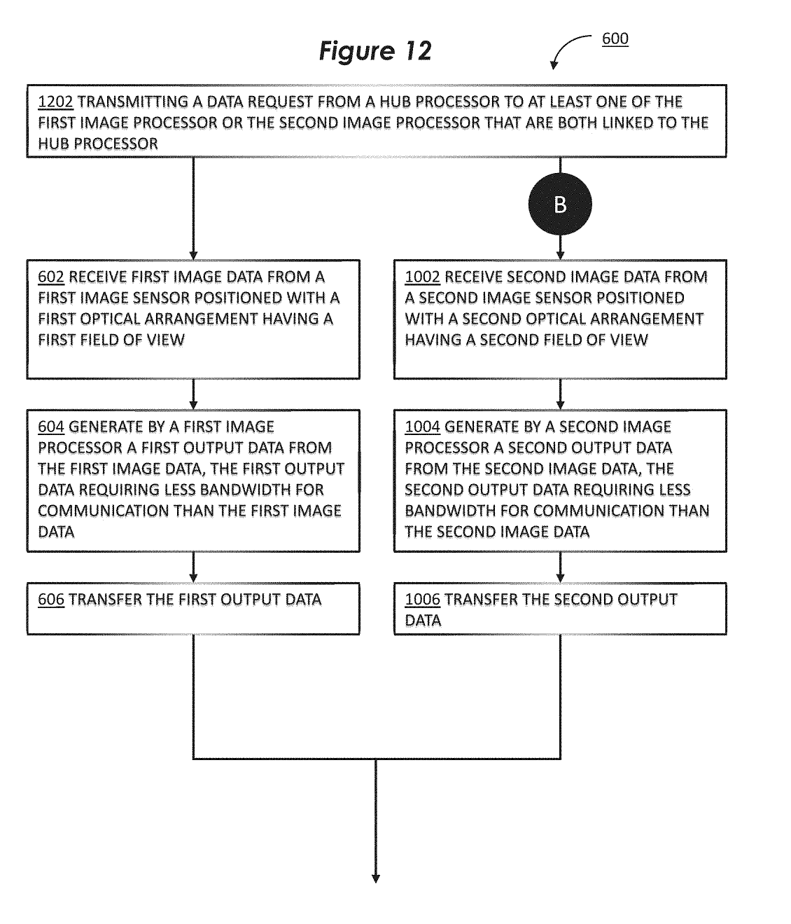

FIG. 12 is a block diagram of a process 600 implemented using an imaging device 400 with edge processing for providing low latency communication of high resolution imagery. In one embodiment, process 600 further includes an operation performed the hub processor 412 of the imaging device 400. The hub processor 412 transmits a data request to at least one of the first image processor 408 and/or the second image processor 408N that are both linked to the hub processor 412 via the backplane/hub circuit 410. The hub processor 412 can be coupled to a plurality of the image processor 408 and image processors 408N, such as anywhere from approximately one to thousands of image processors. The backplane/hub circuit 410 provides bidirectional communication between each of the image processor 408 and image processors 408N and the hub processor 412. The backplane/hub circuit 410 can also enable direct communication between the image processor 408 and the image processors 408N. Alternatively, the backplane/hub circuit 410 can enable power and ground distribution in addition to the data linkage. In one particular embodiment, the backplane/hub circuit includes an expansion port that enables scaling of the imaging device 400 with additional imaging devices 400N to be linked to an imaging device 400.

In one embodiment, the hub processor 412 transmits a data request to just one of the first image processor 408 and/or the second image processor 408N. The hub processor 412 has a record of which image processor 408 or 408N has access to image data of a particular field of view. Thus, in the instance where a data request can be satisfied by a particular image processor 408 or 408N, the hub processor 412 can transmit the data request to only that image processor 408 or 408N to obtain the image data. For instance, if image processor 408 has access to image data for a field of view associated with a segment of a parking lot of a shopping center where a particular vehicle is located, the hub processor 412 can make the request to the image processor 408 for some or all of the image data (e.g., only image data associated with a license plate of the particular vehicle at a specified resolution).

In one embodiment, the hub processor 412 transmits a data request to two or more of the first image processor 408 and the second image processor 408N. The hub processor 412 has a record of which image processors 408 or 408N have access to image data of certain fields of view. Thus, in the instance where a data request cannot be satisfied by a particular image processor 408 or 408N alone, the hub processor 412 can transmit the data request to image processor 408 for a first portion of the image data and the data request to the image processor 408N for a second portion of the image data. For instance, if image processor 408 has access to image data for a field of view associated with a segment of a parking lot of a shopping center where a particular vehicle is driving and if the image processor 408N has access to image data for a different field of view associated with a different segment of the parking lot of the shopping center where the particular vehicle is moving into, the hub processor 412 can make the data request to the image processor 408 for some of the image data (e.g., only image data associated with the particular vehicle at a specified resolution) and can make the data request to the image processor 408N for additional image data (e.g., more image data associated with the particular vehicle at the specified resolution). The hub processor 412 can then receive the image data from each of the image processor 408 and 408N and stitch the image data together to form composite image data (e.g., a video of the vehicle driving through the parking lot at the specified resolution).

Thus, the distribution of the image processor 408 and image processor 408N with a centralized hub processor 412 enables leveraging of the processing power of the image processor 408 and image processor 408N, as well as their respective access to different image data at ultra-high resolution, to decrease the overall latency of satisfying one or more image requests with high resolution image data.

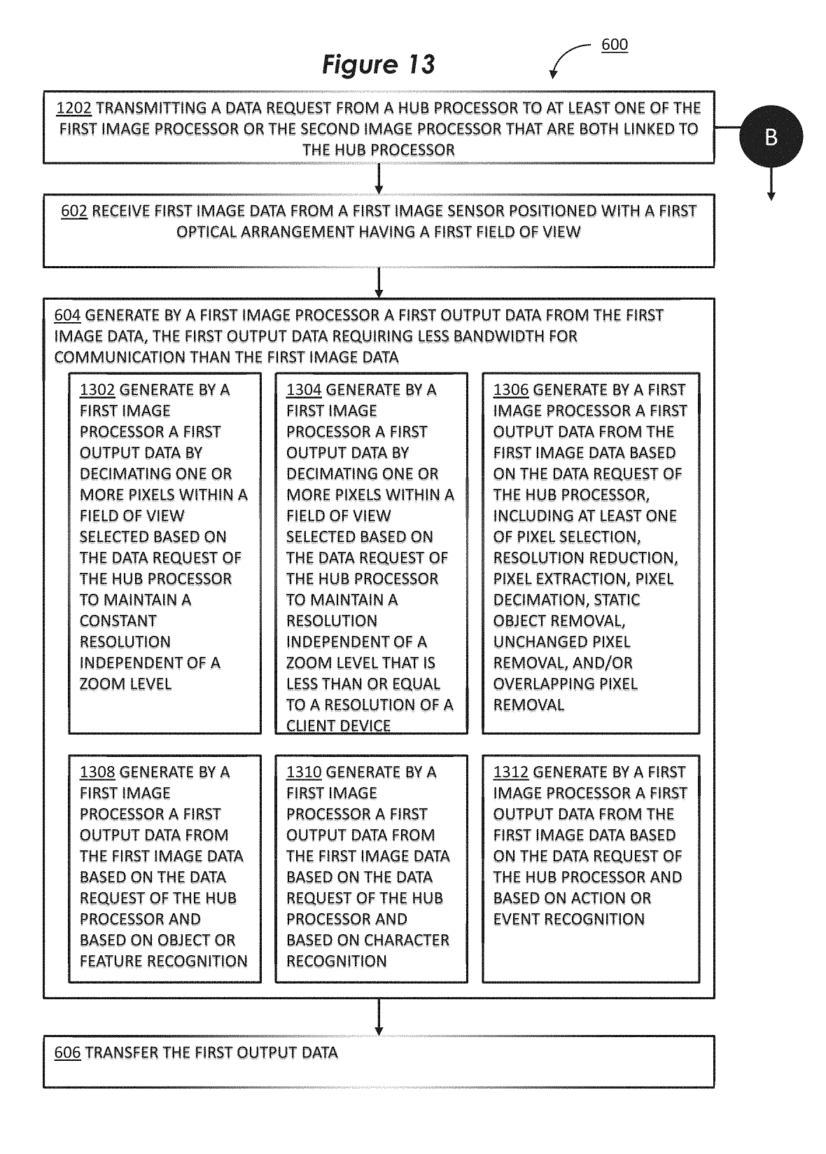

FIG. 13 is a block diagram of a process 600 implemented using an imaging device 400 with edge processing for providing low latency communication of high resolution imagery. In one embodiment, the generate by a first image processor a first output data from the first image data, the first output data requiring less bandwidth for communication than the first image data at 604 includes one or more of generate by a first image processor a first output data by decimating one or more pixels within a field of view selected based on the data request of the hub processor to maintain a constant resolution independent of a zoom level at 1302; generate by a first image processor a first output data by decimating one or more pixels within a field of view selected based on the data request of the hub processor to maintain a resolution independent of a zoom level that is less than or equal to a resolution of a client device at 1304; generate by a first image processor a first output data from the first image data based on the data request of the hub processor, including at least one of pixel selection, resolution reduction, pixel extraction, pixel decimation, static object removal, unchanged pixel removal, and/or overlapping pixel removal at 1306; generate by a first image processor a first output data from the first image data based on the data request of the hub processor and based on object or feature recognition at 1308; generate by a first image processor a first output data from the first image data based on the data request of the hub processor and based on character recognition at 1310; or generate by a first image processor a first output data from the first image data based on the data request of the hub processor and based on action or event recognition at 1312.

In one embodiment, the image processor 408 generates a first output data by decimating one or more pixels within a field of view selected based on the data request of the hub processor 412 to maintain a constant resolution independent of a zoom level at 1302. The image processor 408 has access to ultra-high resolution imagery, but can discard or decimate pixels or portions of that imagery based on what is needed or requested, such as by the hub processor 412. In the instance where the hub processor 412 requests a particular zoom level and portion of the image data from the image processor 408, the image processor 408 can select that zoom level and portion of the image data and decimate unneeded portions of the image data. Within the selected zoom level and portion of the image data, the image processor 408 can further decimate pixels to maintain a specified resolution. The amount of pixel decimation by the image processor 408 will inversely vary with the size of the field of view due to the vary large number of pixels and image data that the image processor has access to. That is, with a larger field of view more pixels are decimated as compared to a smaller field of view where fewer pixels are decimated to maintain approximately the same resolution and visual acuity. The resolution can be established based on a requesting device screen resolution or an average high screen resolution or a based on another specified value. The amount of pixel decimation within a selected area can be evenly distributed throughout (e.g. every other pixel, every third pixel, etc) or can unevenly be distributed (e.g., more pixels removed toward edges or with respect to background or static imagery).

In one embodiment, the image processor 408 generates a first output data by decimating one or more pixels within a field of view selected based on the data request of the hub processor 412 to maintain a resolution independent of a zoom level that is less than or equal to a resolution of a client device 418 at 1304. The image processor 408 can select the portion and zoom level of the image data and then determine how much pixel decimation to perform within that selected portion to reduce the resolution to the maximum screen resolution of the client device 418. For instance, if the client device is MACBOOK PRO with a screen resolution of 2560-by-1600, the hub processor 412 can make the request of the image processor 408 for the portion of the image data at approximately 2560-by-1600. The image processor 408 can decimate excess pixels to reduce the resolution to a still high resolution of 2560-by-1600 for the selected area (e.g., a close up image of a face of a person at a checkout counter of a convenience store at 2560-by-1600 with few or none of the excess ultra-high resolution imagery being decimated). The hub processor 412 can have a default specified resolution for requesting image data or can have the specified resolution vary based on a determination of the requesting device screen resolution, which can be provided or automatically determined. In this manner, the processor 408 obtains high resolution imagery for a client device 418 in an efficient manner without unnecessarily burdening the bandwidth availability of the wireless network interface 414 or the communication link 416.

In one embodiment, the image processor 408 generates a first output data from the first image data based on the data request of the hub processor 412, including at least one of pixel selection, resolution reduction, pixel extraction, pixel decimation, static object removal, unchanged pixel removal, and/or overlapping pixel removal at 1306. The image processor 408 can perform initial pixel reduction through a variety of methods to transmit what is needed at a high resolution to minimize bandwidth requirements. With pixel selection, the image processor 408 selects the pixels from the available image data that correspond to the data request from the hub processor (e.g., pixels associated with a ship moving through a shipping lane). With resolution reduction, the image processor 408 reduces a resolution of a selected portion of the image data from an ultra-high resolution to a high resolution that may be dependent on the device screen resolution or another specified value (e.g., eliminate five percent of pixels of a close up field of view because these pixels exceed a resolution request). With pixel extraction, the image processor 408 can extract pixels of unselected portions that may be subject to a future request or that pertain to a static object (e.g., a land mass is unchanging and image data of the land mass can be transmitted at off-peak times to reduce the bandwidth of future transmissions). Pixel decimation can include the image processor 408 deleting or removing for storage certain pixels that are associated with an unrequested area or within a requested area that exceed resolution requirements of a data request (e.g., delete pixels other than those that are associated with a change in retinal pattern for an individual). For static object removal, the image processor 408 can remove image data that is associated with a static object (e.g., the couch in a living room does not move, so pixels associated with the couch can be deleted). For unchanged pixel removal, the image processor 408 can determine that image data has not changed since a previous transmission and remove that image data to minimize bandwidth requirements (e.g., image data as video data having twenty frames per second can include a person reading a book that has not moved or changed over the course of sequential frames, so the image data associated with the person reading a book can be deleted until such time that the person moves). For overlapping pixels, the image processor 408 can omit any image data that is subject of a contemporaneously additional request (e.g., multiple users request a view of a protest march from a satellite-based imaging device 400 and the image processor can select and transmit the image data of the protest march one time for redistribution to the multiple users).

In one embodiment, the image processor 408 generates a first output data from the first image data based on the data request of the hub processor 412 and based on object or feature recognition at 1308. The hub processor 412 can make a request for a specified area and zoom level of the image data from the image processor 408 or can, alternatively, specify and object or feature condition that the image processor 408 can use to determine which image data to transmit. Thus, the hub processor 412 can shift the work to the image processor 408 and/or 408N to determine which image data is needed based on specified conditions. For instance, the image processor 408 can perform image recognition with access to the ultra-high resolution imagery to identify a particular object or feature. Once identified, the image data or other data pertaining to the object or feature can be transferred. For example, the image processor 408 can be programmed to identify food packaging and determine when food is low or exhausted (e.g., when milk is being poured, determine whether the milk is low and what brand of milk is being poured, and transmit an instruction to reorder milk of that brand when needed). As an additional example, the image processor 408 can be programmed to identify a change in appearance of an individual (e.g., determine whether a person has a new skin growth or coloration on the face and then transmit image data associated with the feature to a clinician for review and analysis).

In one embodiment, the image processor 408 generates a first output data from the first image data based on the data request of the hub processor 412 and based on character recognition at 1310. The image processor 408 may be programmed to perform character recognition with full access to the ultra-high resolution imagery and to return that character information as output with or without any image data. For example, the hub processor 412 can request license plate data from all vehicles traveling down a particular road or parking in a particular lot. The image processor 408 can analyze image data and extract the requisite text data for the license plates. The text data may be returned without any additional image data thereby minimizing the bandwidth requirements for such transmission. Alternatively, a client device 418 may be viewing image data transmitted from the imaging device and submit a query as to what alphanumeric text is present in a particular region of the image data. The image processor 408 can perform text recognition on the image data associated with the specified particular region and return the alphanumeric text. As a further example, the image processor 408 can be programmed to monitor for text on food packaging within a home and compare that text to known allergens or food preference data. In an event that the image processor 408 detects a possible allergen or violation in food preference, the image processor 408 can transmit a warning indication for output via the client 418 (e.g., food notification: the snack bars in the kitchen have dairy milk as an ingredient).

In one embodiment, the image processor 408 generates a first output data from the first image data based on the data request of the hub processor 412 and based on action or event recognition at 1312. The image processor 408 can be programmed to monitor for a particular action or event and transfer image data associated with that particular action or event to the hub processor 412. The actions or events can include key or wallet placement within a home, an airplane flying in a particular region, a boat positioned in a particular area, a group of people congregating beyond a specified number, a volcanic eruption, etc. For example, the image processor 408 can be programmed to continuously monitor aircraft flights from a satellite based imaging device 400. Upon detecting a particular aircraft in a particular region, such as a restricted or prohibited area, the image processor 408 can determine whether the aircraft has a flight plan or is otherwise cleared through the prohibited or restricted area. In the event the particular aircraft is unknown, the image processor 408 can obtain image data of the aircraft and transfer that image data to the hub processor 412, which may obtain additional image data for the particular aircraft from the additional image processors 408N.

FIG. 13 is a block diagram of a process 600 implemented using an imaging device 400 with edge processing for providing low latency communication of high resolution imagery. In one embodiment, the generate by a first image processor a first output data from the first image data, the first output data requiring less bandwidth for communication than the first image data at 604 includes one or more of generate by a first image processor a first output image data of a specified resolution from the first image data based on the data request of the hub processor at 1402, generate by a first image processor a first output image data of a specified field of view from the first image data based on the data request of the hub processor at 1404, generate by a first image processor a first output image data of a specified zoom level from the first image data based on the data request of the hub processor at 1406, generate by a first image processor a first output image data of a specified object or feature from the first image data based on the data request of the hub processor at 1408, generate by a first image processor a first output data of a specified character or text from the first image data based on the data request of the hub processor at 1410, or generate by a first image processor a first output data from the first image data based on the data request of the hub processor and in response to a specified action or event at 1412.

In one embodiment, the image processor 408 generates a first output image data of a specified resolution from the first image data based on the data request of the hub processor 412 at 1402. The hub processor 412 can determine the specified resolution based on a user specified resolution, a device specified resolution, a default resolution, or an available bandwidth resolution. With respect to a user specified resolution, the hub processor 412 can receive this specified resolution as part of a request received form the client 418. For instance, the user specified resolution can be 1366×768 or 1024×768 or some other resolution. The hub processor 412 then requests image data from the image processor 408 at the user specified resolution. Alternatively, with respect to the device specified resolution, the hub processor 412 can automatically determine the resolution based on a device associated with the client 418. For example, the hub processor 412 can determine that the device is a SAMSUNG GALAXY device with a resolution of 1920×1080 and formulate a request for image data from the image processor 408 based on the same. The hub processor 412 can also make requests for image data at a default pre-specified resolution from the image processor 408 (e.g., unless specified otherwise use 5120×2880 pixels as the resolution of image data). The default resolution can change or fluctuate, such as depending upon bandwidth availability for the wireless network interface 414 or the communication link 416. Moreover, the resolution requested or defaulted can be overridden, such as the hub processor 412 further reducing the resolution below that which is requested based upon higher demand for image data, demand for image data that exceeds a specified value, or available bandwidth being below a specified value.

In one embodiment, the image processor 408 generates a first output image data of a specified field of view from the first image data based on the data request of the hub processor 412 at 1404. The hub processor 412 has access to information regarding the overall field of view accessible to the imaging unit 402 and any additional imaging units 402N. Thus, when a request is made for a particular field of view to the hub processor 412, an identification of the image processor 408 is made based on the image processor 408 having access to image data of the particular field of view. The hub processor 412 then transmits the request to the image processor 408 for the image data of the particular field of view. Note that the particular field of view being requested and the overall field of view accessible to the image processor 408 are not necessarily the same. The particular field of view may be a small portion of the overall field of view or the particular field of view may be an entirety of the overall field of view. The image processor 408 obtains image data associated with the particular field of view and transfers the image data to the hub processor. For instance, the particular field of view can include a live view of a business entrance from a street-corner mounted imaging device 400 having an array of imaging units 402 and 402N providing individual fields of view that combine to a total 360 degree overall field of view.

In one embodiment, the image processor 408 generates a first output image data of a specified zoom level from the first image data based on the data request of the hub processor 412 at 1406. The image sensor 406 can be fixed with a field of view defined by the optics 404. However, due to the ultra-high resolution of the image sensor 406, the image processor 408 can digitally recreate panning and zooming by selective retention of pixels available from the image sensor 406. With respect to zooming, the image processor 408 can retain fewer pixels when zoom is less and the specified field of view is larger. Likewise, the image processor 408 can retain more pixels when zoom is greater and the specified field of view is smaller. The image processor 408 therefore selects the pixels and the retention rate from the image data available based on a request from the hub processor for a specified zoom level. An example of this operation is illustrated in FIG. 5 at 504 where the indicia on the wheel is visible through increased pixel retention based on selection 503.

In one embodiment, the image processor 408 generates a first output image data of a specified object or feature from the first image data based on the data request of the hub processor 412 at 1408. The hub processor 412 can request image data of a particular object or feature from any or all of the imaging units 402 and 402N. The image processor 408 then monitors the image data and through object or feature image recognition detects whether the specified object or feature is present. Upon detection, the image processor 408 selects image data including the object or feature and transfers the image data to the hub processor 412. The selected image data can include only pixels of the object or feature or can also include a portion surrounding the object or feature. For example, the hub processor 412 can request any imagery of ice calving, which request can be provided to the image processor 408. The image processor 408 may transmit nothing or an indication that no ice calving has been detected on a periodic basis. However, upon the image processor 408 detecting ice calving, the image data associated with that event is retained with resolution reduction to the specified level and transferred to the hub processor 412. The hub processor 412 may then stitch the image data received of the ice calving from a plurality of the image processors 402N prior to communication to the client 418.

In one embodiment, the image processor 408 generates a first output data of a specified character or text from the first image data based on the data request of the hub processor 412 at 1410. The image processor 408 can be programmed to recognize and/or interpret text. For instance, the image processor 408 can recognize an aircraft tail identification number and determine a destination and arrival time for the aircraft tail identification number based on flight plan registry information. Based on the foregoing, the image processor 408 can provide an alert, such as a text indication that the aircraft is running behind schedule based on the geolocation and travel speed of the aircraft and based on the destination and arrival time obtained based on character recognition of the aircraft tail identification number. Thus, the image processor 408 can output text data in addition to image data and the text data can be interpretative data that is based on data sources and recognized characters within the image data.

In one embodiment, the image processor 408 generates a first output data from the first image data based on the data request of the hub processor 412 and in response to a specified action or event at 1412. The image processor 408 can be programmed to monitor image data for one or more static objects to determine whether the one or more static objects have changed or moved. The image processor 408 can transfer updated image data for the one or more static objects in response to detected change or movement in the one or more static objects. The image data from the one or more static objects can be used by the hub processor 412 or a server in the communication link 416 to gap-fill any image data that omits the one or more static objects. Additionally, the image processor 408 can be programmed to monitor for other events or actions, such as daytime turning to nighttime, placement of keys within a home, changes in personal behavior or appearance indicative of health or emotional issues, migration of animals, theft of an article, rain or drought, etc. Upon detection of one or more events or actions, the image processor 408 can transmit a textual or binary indication of such event or action and/or image data associated with the event or action (e.g., a field of view and zoom to the event or action with resolution reduction to that of a requesting device screen resolution less any static imagery or overlapping imagery).

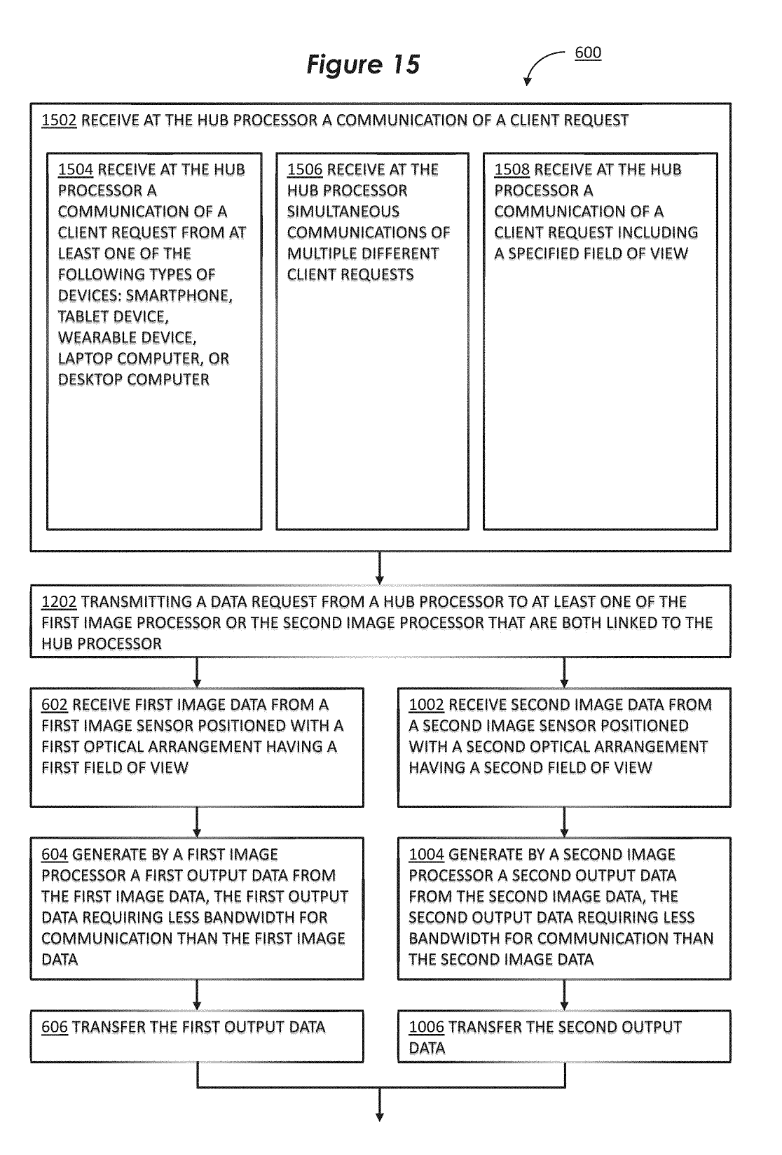

FIG. 15 is a block diagram of a process 600 implemented using an imaging device 400 with edge processing for providing low latency communication of high resolution imagery. In one instance, the process 600 further includes an operation of receive at the hub processor a communication of a client request at 1502.

In certain embodiments, the receive at the hub processor a communication of a client request at 1502 further includes one or more of receive at the hub processor a communication of a client request from at least one of the following types of devices: smartphone, tablet device, wearable device, laptop computer, or desktop computer at 1504, receive at the hub processor simultaneous communications of multiple different client requests at 1506, or receive at the hub processor a communication of a client request including a specified field of view at 1508.

In one embodiment, the hub processor 412 receives a communication of a client request from at least one of the following types of devices 418: smartphone, tablet device, wearable device, laptop computer, or desktop computer at 1504. The devices 418 can include personal computers, server computers, wearable devices, other imaging devices 400, home monitoring devices (e.g., NEST), personal home assistant devices (e.g., ECHO), automobile or vehicle devices, internet-of-thing type devices, or any other electronic device. In one particular example, the hub processor 412 includes a websocket for communication with client device 418 running a browser.

In one embodiment, the hub processor 412 receives simultaneous communications of multiple different client requests at 1506. The hub processor 412 is configured to receive and handle multiple simultaneous or near simultaneous requests for image data from the imaging device 400. A plurality of different clients 418 at different geographical locations and with different interests or needs can each independently transmit requests to the imaging device 400 for receipt by the hub processor 412. The hub processor 412 then satisfies the multiple requests with different image data or other output data as demanded. For example, a first user 418 with an IPHONE may request image data from the imaging device 400 for a northbound street view of 10× effective zoom in video form. A second user 418N with a DELL desktop computer may request image data from the imaging device 400 for a westbound view of a sidewalk and store entrance of 3× effective zoom in static image form. The hub processor 412 can receive the requests and determine which of the image processor 408 and 408N have image data accessible to satisfy the requests based on their respective fields of view. The hub processor 412 can the create and transmit sub requests for the image data from the identified image processors 408 and/or 408N. Each of the image processors 408 and/or 408N retain the requested image data through selection and/or pixel decimation to reduce the resolution to that appropriate for the zoom level and screen resolution of the DELL and the IPHONE. The hub processor 412 obtains the image data from the image processor 408 and/or 408N and returns the northbound video at 10× to the IPHONE at its screen resolution and the westbound static image at 3× to the DELL at its screen resolution.

In one embodiment, the hub processor 412 receives a communication of a client request including a specified field of view at 1508. The specified field of view can span multiple fields of view of the imaging units 402 and 402N. That is, a client 418 can transmit a request to the hub processor 412 for a specified field of view of a driveway area. The imaging device 400 may have a plurality of imaging units 402 and 402N that each have fields of view that are sections of a three-hundred and sixty degree composite field of view. The hub processor 412 receives the specified field of view requested from the client 418 and determines which of the imaging processors 408 and 408N have access to image data associated with the specified field of view. It is possible that the specified field of view can be satisfied by a single imaging unit 402 and the hub processor 412 can transmit the specified field of view request to that particular image processor 408. However, it is also conceivable that the driveway specified field of view actually spans the field of view of two or three or more imaging units 402 and 402N. Thus, the specified field of view of the client request may fall within a single field of view of the imaging unit 402 or may span multiple fields of view of additional imaging units 402N. The hub processor 412 manages this overlap so that a request for a specified field of view can be distributed to the appropriate image processor 408 and/or 408N to satisfy the request. The image processors 408 and/or 408N can return the requested image portions from their respective image data, whereby the hub processor 412 can stitch the image data together for a composite image of the driveway.

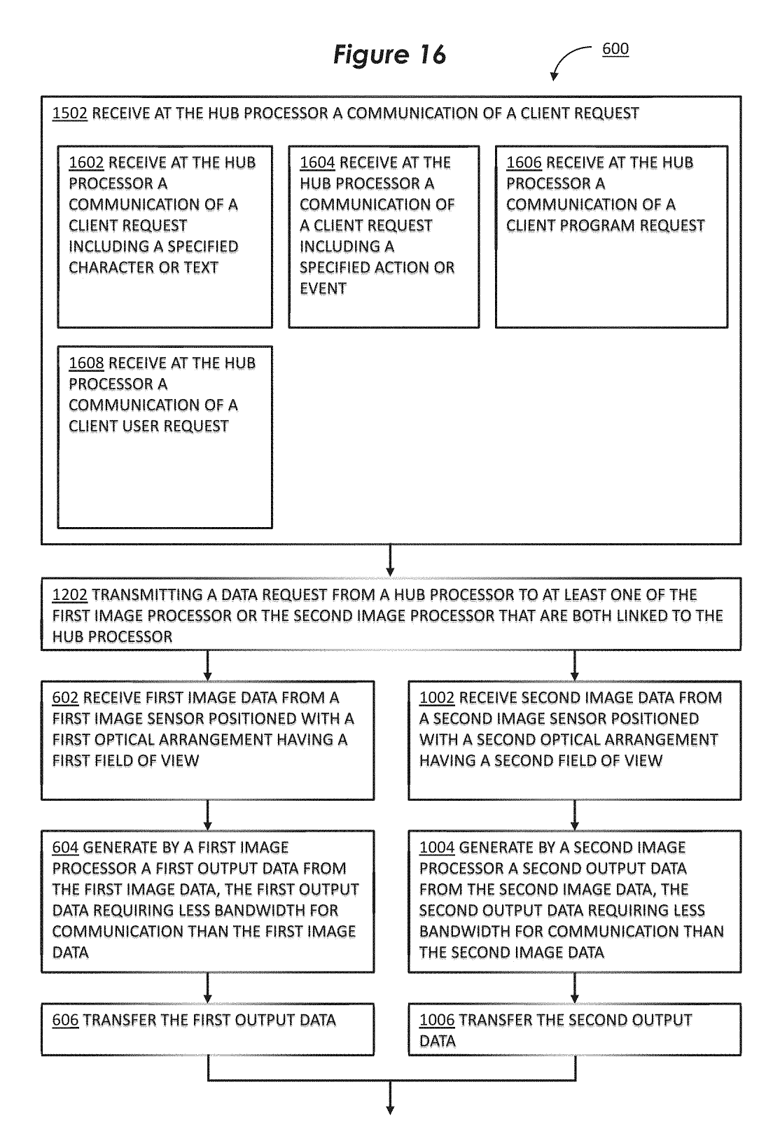

FIG. 16 is a block diagram of a process 600 implemented using an imaging device 400 with edge processing for providing low latency communication of high resolution imagery. In one instance, the receive at the hub processor a communication of a client request at 1502 includes one or more of receive at the hub processor a communication of a client request including a specified character or text at 1602, receive at the hub processor a communication of a client request including a specified action or event at 1604, receive at the hub processor a communication of a client program request at 1606, or receive at the hub processor a communication of a client user request at 1608.

In one embodiment, the hub processor 412 receives a communication of a client request including a specified character or text at 1602. The hub processor 412 can accept a request for text or characters and distribute this request to the image processor 408 and/or the image processor 408N. The image processor 408 and 408N can monitor their respective image data for the text or character through image or character recognition. Upon detecting the text or character, the image processor 408 and/or 408N can return an indication of detection, the text or character detected, and/or image data. For example, the hub processor 412 can receive an amber alert license plate number and can distribute a request for image data associated with a detection of the license plate number. Each of the image processor 408 and/or 408N monitor for the license plate number within their respective image data and upon detecting the license plate number, transmit video image data of an associated vehicle to the hub processor 412.

In one embodiment, the hub processor 412 receives a communication of a client request including a specified action or event at 1604. The hub processor 412 can accept a request for an action or event and distribute this request to the image processor 408 and/or the image processor 408N. The image processor 408 and 408N can monitor their respective image data for the action or event through image or character recognition. Upon detecting the action or event, the image processor 408 and/or 408N can return an indication of detection and/or image data. For example, the hub processor 412 can receive a request for notification when a child returns home and can distribute a request for image data associated with detection of the child. Each of the image processor 408 and/or 408N monitor for the child within their respective image data and upon detecting the child, such as through facial pattern recognition, transmit a text indication or binary indication to the hub processor 412.

In one embodiment, the hub processor 412 receives a communication of a client program request at 1606. The hub processor 412 can host an application program that can be uploaded to the imaging device 400 for local access to high resolution imagery, with binary, text, or image data output from the application program. The hosted application programs can be 3^{rd} party programs that can be fully customizable to the needs of a particular individual or company. Additionally or alternatively, an API can be provided at the hub processor 412 to enable input/output interfacing with one or more programs for image analysis and data collection of the hub processor 412. A hub processor 412 with the application program can make requests for image data, event or action detection, object recognition, character or text recognition, and/or other referenced requests. The hub processor 412 can execute on those requests using the image processor 408 and/or 408N. In certain embodiments, the hub processor 412 also can receive a program request from a remote server, client, or other imaging device 400. For instance, one imaging device 400 may determine that none of the image processors 408 on-board have access to the image data and can broadcast or relay requests to one or more other imaging devices 400N.

In one embodiment, the hub processor 412 receives a communication of a client user request at 1608. The hub processor 412 can directly or indirectly link to a client 418, such as via a dial-up connection, internet connection, BLUETOOTH connection, WIFI connection, cellular connection, satellite connection, wireless connection, or wire-based connection. The hub processor 412 can receive requests, such as from a browser or local application client, for image data, object recognition, event or feature detection, character or text identification, or other referenced data. For instance, a client 418 can request a particular field of view, zoom level, and resolution at a particular time and at a particular frame rate. The hub processor 412 can receive this request and leverage the image processor 408 or 408N or another imaging device 400N to satisfy the request.

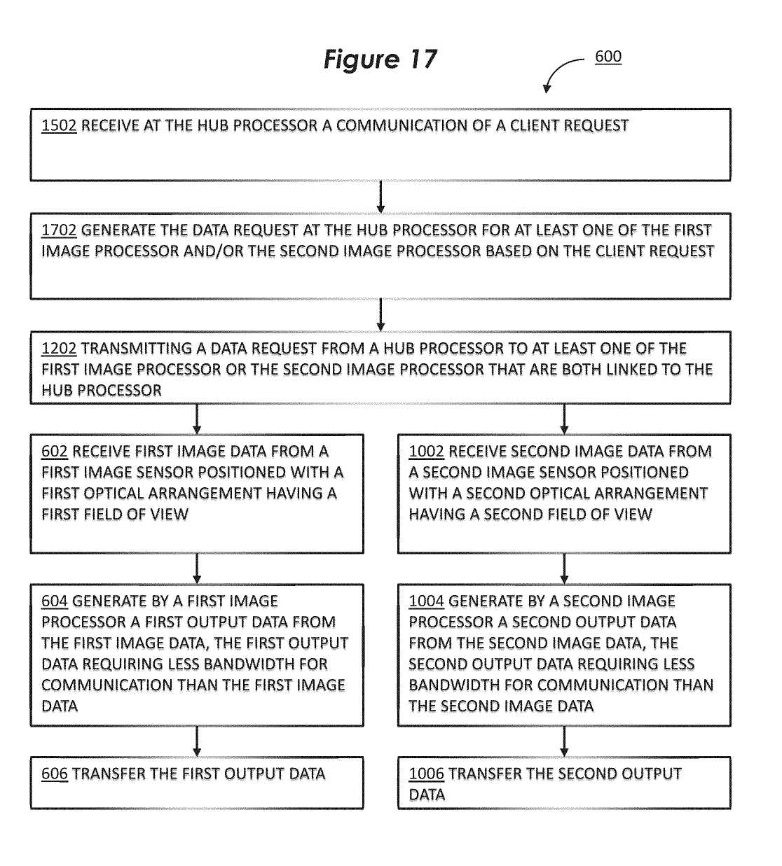

FIG. 17 is a block diagram of a process 600 implemented using an imaging device 400 with edge processing for providing low latency communication of high resolution imagery. In one instance, the process 600 further includes an operation of generate the data request at the hub processor for at least one of the first image processor and/or the second image processor based on the client request at 1702.

In one embodiment, the hub processor 412 receives a client request from client 418 and converts or generates that client request into one or more data requests for particular image processor 408 and/or 408N. The client request is translated without necessarily revealing that translation to the client 418 in order to satisfy that request using one or more of the image processor 408 and 408N, which each have access to different ultra-high resolution imagery corresponding to the respective fields of view of each imaging unit 402 and 402N. The hub processor 412 then obtains the resultant data from the image processor 408 and/or 408N and stitches and/or compresses that resultant data for return to the client 418.

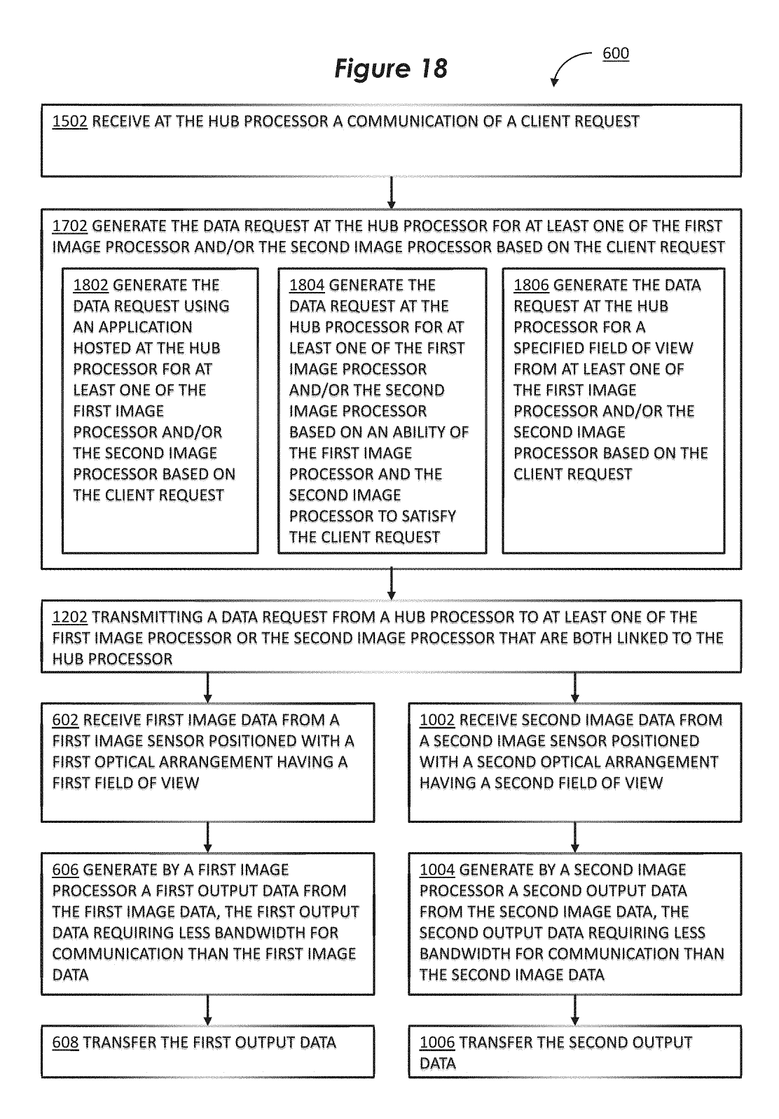

FIG. 18 is a block diagram of a process 600 implemented using an imaging device 400 with edge processing for providing low latency communication of high resolution imagery. In one instance, the generate the data request at the hub processor for at least one of the first image processor and/or the second image processor based on the client request at 1702 includes one or more of generate the data request using an application hosted at the hub processor for at least one of the first image processor and/or the second image processor based on the client request at 1802, generate the data request at the hub processor for at least one of the first image processor and/or the second image processor based on an ability of the first image processor and the second image processor to satisfy the client request at 1804, or generate the data request at the hub processor for a specified field of view from at least one of the first image processor and/or the second image processor based on the client request 1806.

In one embodiment, the hub processor 412 generates the data request using an application hosted at the hub processor 412 for at least one of the first image processor 408 and/or the second image processor 408N based on the client request at 1802. The hub processor 412 can execute one or more third party applications that configure the hub processor 412 to perform one or more functions for one or more outputs. The one or more functions can include any of the following with respect to image data accessible to the processor 408 or processor 408N: event recognition, object recognition, action recognition, feature recognition, text recognition, facial recognition, monitoring, detecting, tracking, analyzing, summarizing, documenting, or otherwise processing of the image data. The output of the one or more third party applications can include one or more of text output, video output, image data output, binary output, no output, summary output, or other similar information. The hub processor 412 is not limited to running one particular 3^{rd} party application and can be configured by a plurality of 3^{rd} party applications that each may perform different functions or provide different outputs in parallel. Furthermore the 3^{rd} party applications can operate in conjunction with other operations of the hub processor 412, such as real-time satisfaction of image requests or non-real time transfers of image data. Thus, the 3^{rd} party applications enable customized configurations of the imaging device 400 to perform operations on image data based on a particular need. For example, the hub processor 412 can be configured by a 3^{rd} party application that monitors image data for drought patterns over a geographic area from a satellite. The application can analyze image data from one or more of the image processors 408 and 408N and determine based on color changes that a particular area is experiencing drought. The application can document the time duration of the drought, the measurements or distance or area of the drought, chart the drought with previous year's droughts, and retain pixel image data for the particular area of the drought. This data can be output by the hub processor 412 to the client 418 in real-time or in batch.

In one embodiment, the hub processor 412 can generate the data request for at least one of the first image processor and/or the second image processor based on an ability of the first image processor and the second image processor to satisfy the client request at 1804. The hub processor 412 has access to each of the image processors 408 and 408N, which in turn have access to respective ultra-high resolution imagery for each of their fields of view. The hub processor 412 may also have access to other image data from other imaging devices 400N. The client 418 can transmit a request for data, such as for image data, video data, field of view data, zoom level, resolution, or the like, which request is then processed by the hub processor 412. One operation of the hub processor 412 is to determine from the request which of the image processors 408 and 408N have access to image data needed to satisfy the request. For instance, the hub processor 412 can transmit a request for a particular field of view and zoom level to the image processor 408 based on a determination that the image processor 408 has access to high resolution imagery of a particular characteristic (e.g., 0-35 degrees, left quadrant, ultra-high resolution image data of spot imager, or high resolution image data of global imager). The hub processor 412 can also transmit multiple requests to a plurality of the image processor 408 and 408N. This can occur simultaneously or in series. For instance, the hub processor 412 can seek image data or other output from the image processor 408, but the image processor 408 may not be able to satisfy the request. At such time, the hub processor 412 can transmit the request to the additional image processor 408N or to an entirely different imaging device 400N. For example, the client 418 can request a real-time video of a particular highway to determine the traffic congestion. The hub processor 412 can determine that the image processor 408 and the image processor 408N together have access to at least some of the highway image data. The hub processor 412 can request the image data of the highway and the image processors 408 and 408N can return the image data of the highway at the specified resolution of the request. The hub processor 412 can then stitch and compress the received image data for transmission to the client 418.

In one embodiment, the hub processor 412 can generate the data request for a specified field of view from at least one of the first image processor and/or the second image processor based on the client request 1806. The client 418 can request a particular field of view and zoom level, which request can be received by the hub processor 412. The particular field of view and zoom level may not be entirely contained within the image data to which a single image processor 408 has access. Accordingly, the hub processor 412 can determine that the image processor 408 and the image processor 408N each have a portion of the image data needed to satisfy the request of the client 418. The hub processor 412 can delineate which pixels, area, and resolution are requested from each of the image processors 408 and 408N. Upon receiving the partial image data from each of the image processors 408 and 408N, the hub processor 412 can stitch or combine the image data into an overall image that corresponds to the field of view and zoom request of the client 418. The stitching or combining may require that certain portions of the image data from each of the image processors 408 and 408N are dispensed or decimated or blended by the hub processor 412 to account for any overlap in the imaging unit 404 and 404N fields of view. For example, the image processor 412 can receive a request for a field of view corresponding to any suspicious behavior within a casino (e.g., false shuffles, Roulette past posting, hidden cameras, card switching, chip color ups, etc.). The hub processor 412 can determine that the image processors 408 and 408N together have access to image data of particular tables or game areas. The image processors 408 and 408N can perform pattern and image recognition on their respective accessible image data to detect instances of cheating or possible cheating and return select image data of the occurrences to the hub processor 412. The hub processor 412 can stitch the image data from each of the image processors 408 and 408N to an overall field of view and return that image data to a client 418 for viewing.

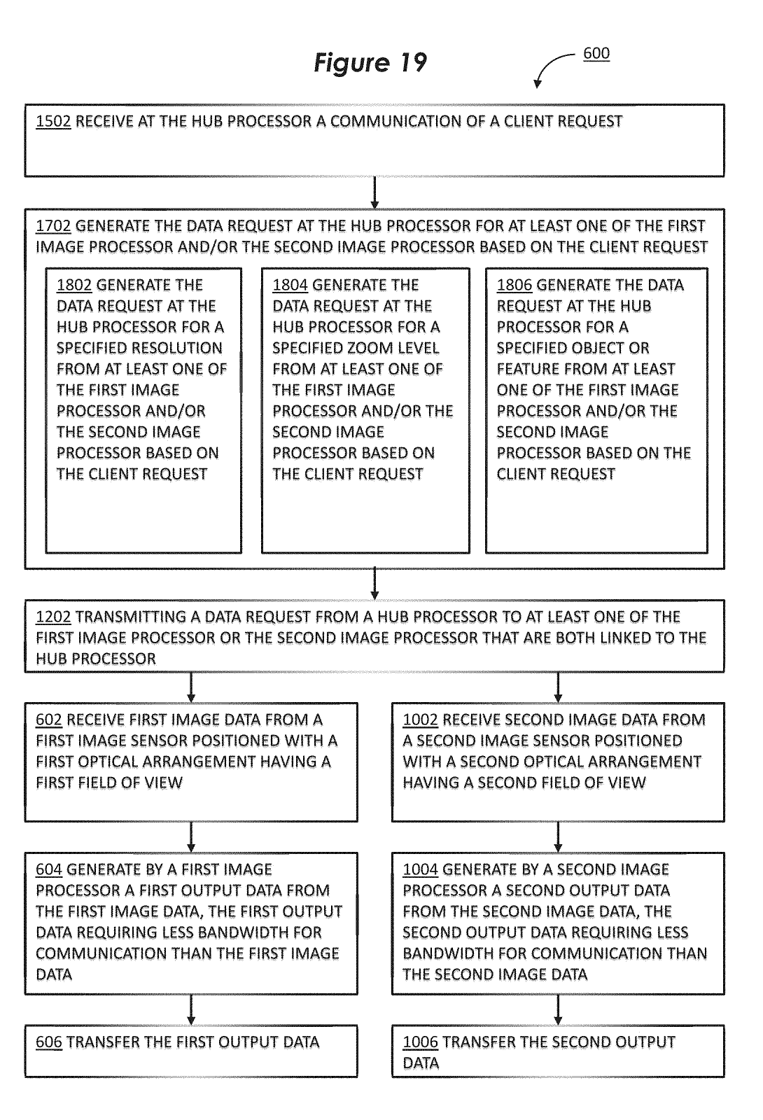

FIG. 19 is a block diagram of a process 600 implemented using an imaging device 400 with edge processing for providing low latency communication of high resolution imagery. In one instance, the generate the data request at the hub processor for at least one of the first image processor and/or the second image processor based on the client request at 1702 includes one or more of generate the data request at the hub processor for a specified resolution from at least one of the first image processor and/or the second image processor based on the client request at 1802, generate the data request at the hub processor for a specified zoom level from at least one of the first image processor and/or the second image processor based on the client request at 1804, or generate the data request at the hub processor for a specified object or feature from at least one of the first image processor and/or the second image processor based on the client request at 1806.

In one embodiment, the hub processor 412 generates the data request for a specified resolution from at least one of the first image processor 408 and/or the second image processor 408N based on the client request at 1802. The client request may include metadata that specifies the type of device 418 or the resolution desired in addition to any field of view or zoom level data. For instance, if the device 418 is an APPLE IWATCH that is requesting a real time video feed of a particular isle at a store (e.g., to determine whether a particular product is stocked), the hub processor 412 can tailor the request of the image processor 408 to decimate pixels down to the screen resolution of the APPLE IWATCH (e.g., 272×340 pixels or 312×390 pixels). Additional resolution of the image data from the image processor 408 may be unnecessary in this case given the limiting factor of the screen resolution of the client device 418. However, the client device 418 can also transmit a request for image data of a specified resolution value that exceeds that of the screen resolution of the client device 418. For instance, the APPLE IWATCH may simply be downloading the image data for another device or for print, in which case a higher resolution may be desired and specified. Thus, the hub processor 412 can scale the resolution up or down based on the specified resolution of a request received from the client 418.

In one embodiment, the hub processor 412 can generate the data request for a specified zoom level from at least one of the first image processor and/or the second image processor based on the client request at 1804. The hub processor 412 can initialize with an overall scene view comprised of image data of a plurality of the imaging units 402 and 402N provided to the client 418 at a specified resolution. The client 418 can select from within the overall scene view a segment or portion, such as through a box, finger gesture (e.g., pinch and spread or pinch and join type movement on a touch screen), pointer, touch indication, voice selection, or other similar manner. The selection of the portion of the overall scene view can be transmitted form the client 418 to the hub processor 412. The hub processor 412 can then obtain the relevant pixels from the image processor 408, which relevant pixels will be for subset area and will be a result of less pixel decimation within that subset area by the image processor 408 to maintain high visual acuity for the more focused area. For example, in response to a detected robbery at a convenience store (e.g., detected by the image processor 408 based on a gun being presented), the hub processor 412 can transmit to the client 418 an overall scene of the robbery stitched together from a plurality of the image processors 408 and 408N. A law enforcement or security person can view the robbery in real-time via the high resolution video provided and select a portion of the video corresponding to a subject's face. The hub processor 412 can then select an area of the image data corresponding to the subject's face and reduce the amount of pixel decimation to maintain high visual acuity and return that image data to the client 418. The image data can track to the subject's face as real-time video to assist with recognition or identification of the subject.

In one embodiment, the hub processor 412 can generate the data request for a specified object or feature from at least one of the first image processor and/or the second image processor based on the client request at 1806. The hub processor 412 can handle an array of different types of requests, including requests for image data associated with a particular object or feature even if that object or feature is not known to be present in image data of any of the imaging unites 402 and 402N of the imaging device 400. The hub processor 412 can leverage the image processors 408 and 408N to identify the object or feature within their respective image data and return a result based thereon. For example, in a law enforcement setting, a request may be made to the hub processor 412 for image data associated with a particular individual known to be a shoplifter (e.g., an image of the shoplifter or a plurality of images associated with the shoplifter can be uploaded to an application of the hub processor 412). The hub processor can make a request to the image processor 408 to perform image recognition on image data associated with a front door of a store to detect and identify the shoplifter. The image processor 408 can perform image recognition on the high resolution image data obtained and determine whether the shoplifter has entered the store. The hub processor 412 can be provided with image data of the shoplifter, such as a real-time video of the shoplifter entering the store. The hub processor 412 can thereafter use the image data obtained from the image processor 408 to alert the additional image processor 408N or additional imaging devices 400 to retain image data of the shoplifter. The totality of the image data or even just a portion thereof or a binary indication of the presence of the shoplifter can be transmitted to the client 418 for review.

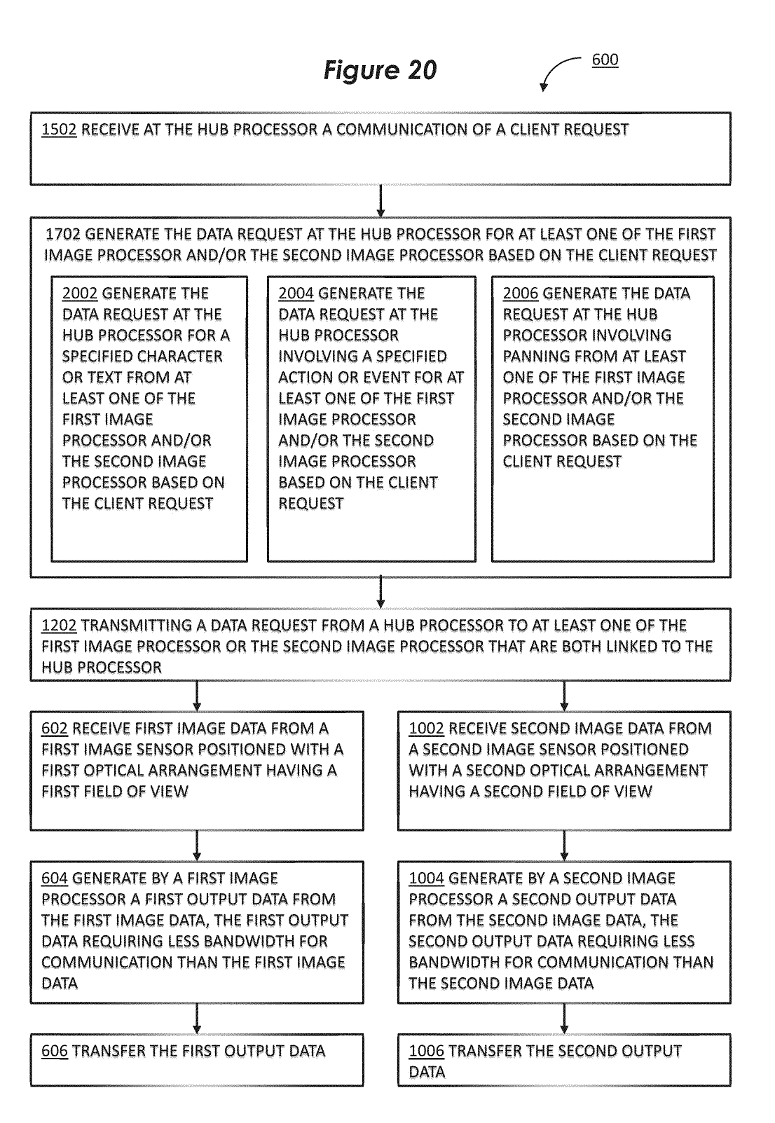

FIG. 20 is a block diagram of a process 600 implemented using an imaging device 400 with edge processing for providing low latency communication of high resolution imagery. In one instance, the generate the data request at the hub processor for at least one of the first image processor and/or the second image processor based on the client request at 1702 includes one or more of generate the data request at the hub processor for a specified character or text from at least one of the first image processor and/or the second image processor based on the client request at 2002, generate the data request at the hub processor involving a specified action or event for at least one of the first image processor and/or the second image processor based on the client request at 2004, or generate the data request at the hub processor involving panning from at least one of the first image processor and/or the second image processor based on the client request at 2006.

In one instance, the hub processor 412 generates the data request for a specified character or text from at least one of the first image processor and/or the second image processor based on the client request at 2002. The client 418 can transmit a request for the text or symbols within an image and the hub processor 412 can request character recognition be performed by the image processor 408 with respect to image data to determine the text and/or symbols within the image. For example, in a context of a home environment, a visually impaired person can utilize the imaging device 400 to assist with reading of text, such as newspaper text, magazine text, tablet display text, labels, food item nutritional information, medication prescription directions, internet of things display text, or any other information within or proximate a home. For instance, a person can hold up a medication container and speak a request for reading the medication label indicia. The hub processor 412 can receive the audio request and generate a request to the image processor 408 to perform character recognition on the image data associated with the medication label. The hub processor 412 can then obtain the text result and output the text to a larger display or convert the text to speech for reading aloud.

In one embodiment, the hub processor 412 can generate the data request involving a specified action or event for at least one of the first image processor and/or the second image processor based on the client request at 2004. The hub processor 412 can receive a request from the client 418 for image data and/or other output data triggered based on a specified action or event. The hub processor 412 can generate requests for monitoring for and detecting the specified action or event to the image processors 408 and 408N. Upon detection, the image processor 408 can return image data of the action or event, a binary indication that the action or event was detected, an analysis of the action or event, a statistical summary of the action or event over time, or the like. For example, a client 418 may be associated with a business that sells a product, such as umbrellas. The client 418 can transmit a request for notification of any instance where a person is walking in business attire in the rain without an umbrella. The hub processor 412 can generate a request for the image processor 408 to monitor for and detect any instance of this occurrence. Upon detection, using image recognition and analysis, the image processor 408 can return a high visual acuity close-up zoom image of the person to the hub processor 412 for transmission to the client 418. The client can utilize the image of the person and/or determined identification information to recommend an umbrella to the person (e.g. via FACEBOOK advertising for the person). Many other product examples and scenarios are possible in this embodiment.

In one embodiment, the hub processor 412 generates the data request involving panning from at least one of the first image processor and/or the second image processor based on the client request at 2006. The hub processor 412 can handle panning digitally by selective retention of pixels over time, or via physical movement of one or more of the imaging units 402 or 402N. The client 418 can transmit a request for panning, which may be accomplished through gesture, speech, eye movement, or head movement (e.g., turning of the head while wearing a virtual reality or augmented reality device). The hub processor 412 receives the panning request and obtains the image data required to simulate the panning from the one or more image processors 408 and 408N. This image data is transferred to the client 418 for real-time image or video panning as requested. For example, a user wearing an OCULUS RIFT device 418 may use the imaging device 400 for virtual tourism. The user may turn her head to look upwards at the Sistine Chapel ceiling. The hub processor 412 can then generate a request of the image processors 408 and 408N to return image data that tracks the head movement of the user. In one particular embodiment, the hub processor 412 anticipates the movement of the panning before it occurs and transmits lower resolution imagery to the client 418 in anticipation of such movement.

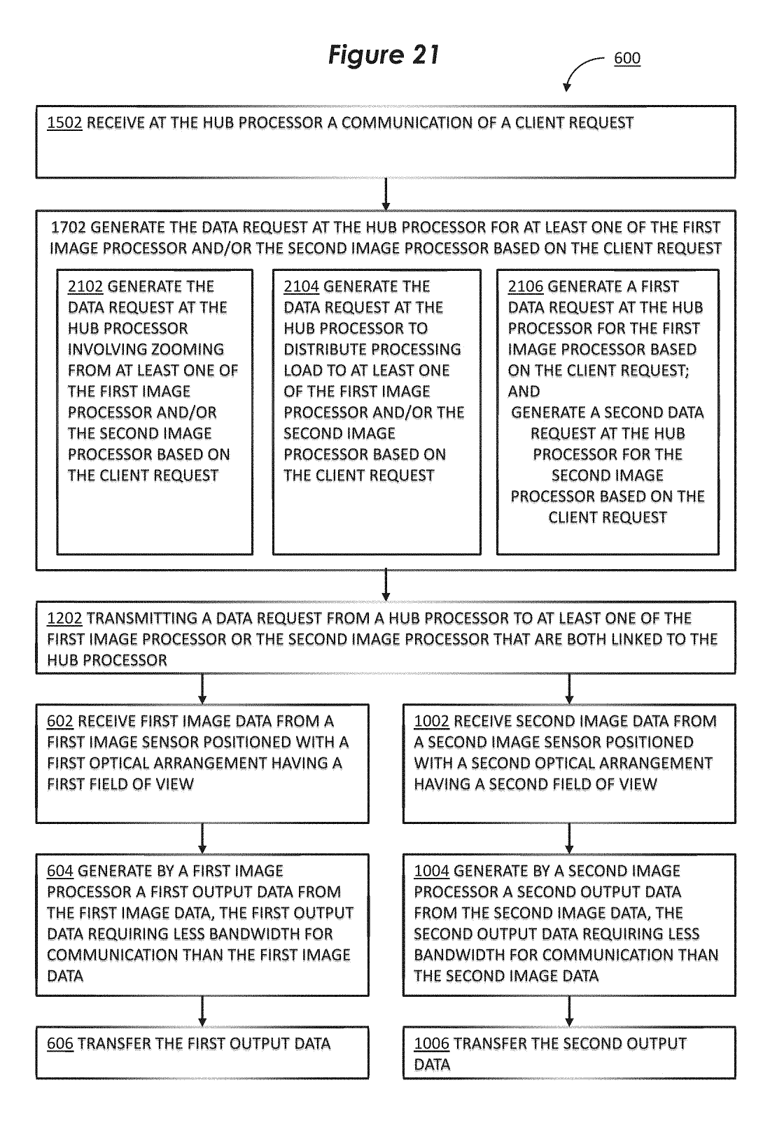

FIG. 21 is a block diagram of a process 600 implemented using an imaging device 400 with edge processing for providing low latency communication of high resolution imagery. In one instance, the generate the data request at the hub processor for at least one of the first image processor and/or the second image processor based on the client request at 1702 includes one or more of generate the data request at the hub processor involving zooming from at least one of the first image processor and/or the second image processor based on the client request at 2102, generate the data request at the hub processor to distribute processing load to at least one of the first image processor and/or the second image processor based on the client request at 2104, or generate a first data request at the hub processor for the first image processor based on the client request and generate a second data request at the hub processor for the second image processor based on the client request 2106.

In one embodiment, the hub processor 412 generates the data request involving zooming from at least one of the first image processor and/or the second image processor based on the client request at 2102. The hub processor 412 can facilitate zoom requests within any field of view of any imaging unit 402 or 402N involving two or more of the imaging units 402 and 402N. The hub processor 412 can obtain the zoom by physical movement of lenses or digitally by area selection and adjustable pixel decimation. In the instance of digital zoom, the hub processor 412 specifies the area of interest and the image processor 408 returns image data associated with that area with pixel decimation that is inversely related to the size of the area (e.g., less pixel decimation for smaller areas to retain high visual acuity). This operation can be referred to as constant resolution or constant acuity independent of zoom and/or field of view. The ultra high resolution imagery accessible to the image processor 408 enables a wide degree in variation in zoom level, enabling, for instance, effective acuity down to to meters or centimeters from tens or hundred meters away. In one particular example, in a business intelligence application, the hub processor 412 can control the image processor 408 to detect one or more instances of facial expressions associated with dissatisfaction. Upon detecting an instance of a facial expression associated with dissatisfaction, the image processor 408 can output a digital zoom image of the person apparently dissatisfied along with a digital zoom image of a nearby employee possibly responsible for the emotion. The close-up high acuity imagery can be transmitted to the client 418 for review.

In one embodiment, the hub processor 412 generates the data request to distribute processing load to at least one of the first image processor and/or the second image processor based on the client request at 2104. Any of the operations disclosed herein with respect to an image processor 408 may be independently performed by an additional image processor 408N. Likewise, any of the operations disclosed herein with respect to an image processor 408 may be alternatively performed by the hub processor 412. Additionally, any of the operations disclosed herein with respect to the hub processor 412 may be performed by any of the image processors 408 or 408N. However, in some embodiments, as discussed, the hub processor 412 manages and triages inbound and outbound communications with a client 418 and leverages any of the image processors 408 and 408N to do processing work with respect to image data accessible to that particular processor (e.g., due to the different fields of view of each of the optics 406 and 406N). The image processors 408 and 408N can therefore independently and simultaneously be performing image recognition, object recognition, feature recognition, pixel subtraction, pixel decimation, overlap reduction, text recognition, analysis, or any other of the operations disclosed herein. The hub processor 412 can manage the work of the individual image processors 408 and 408N, combine or stitch received results, perform second order pixel subtractions and/or decimations, code, compress, or perform or execute any other similar operation.

In one embodiment, the hub processor 412 generates a first data request for the first image processor based on the client request and generates a second data request for the second image processor based on the client request 2106. The hub processor 412 can accept a general client request from the client 418 and generate from that general request specific instructions for each of the image processors 408 and 408N. The process by which the hub processor 412 determines and generates the specific instructions is based upon one or more of the field of view of the optics 406, the image data accessible to the processor 408, a geographical (e.g., GPS) location of the imaging device 400, an orientation of the imaging device 400 (e.g., magnetic heading), overlap present between adjacent imaging units 404 and 404N, processing availability of the imaging unit 408, and other similar factor. For example, the hub processor 412 has access in memory to the orientation and geographical location of the imaging device 400. Accordingly, the hub processor 412 can deduce the accessible fields of view and image data accessible to each of the image processors 408 and 408N based thereon. Based on a request for image data that may span multiple image processors 408 and 408N, the hub processor 412 can identify the two or more image processors 408 and 408N having access to the image data, generate individualized instructions for each of the two or more image processors 408 and 408N, and signal the two or more image processors 408 and 408N to perform pixel selection and decimation and to return the portions of the image data. Each of the image processors 408 and 408N may return different image data based on the individualized request from the hub processor 412. For instance, one image processor 408 may return 25% of the image data and the image processor 408N may return 75% of the image data. As another example, the hub processor 412 can request that all of the image processors 408 and 408N individually monitor foot traffic within a store and return heat map data for the foot traffic. Each of the image processors 408 and 408N can execute on this instruction and, because of their differing access to image data, will each return a portion of the overall heat map. The hub processor 412 can stitch the sections of the heat map together and transmit the composite heat map to a client 418.

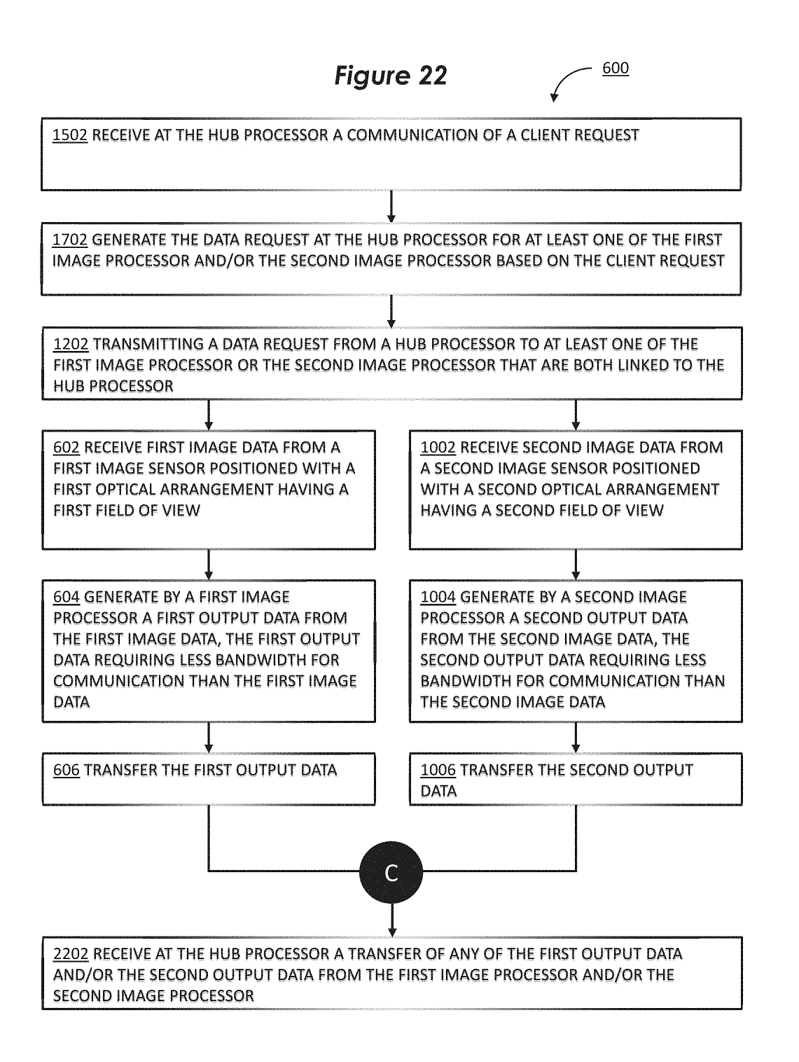

FIG. 22 is a block diagram of a process 600 implemented using an imaging device 400 with edge processing for providing low latency communication of high resolution imagery. In one embodiment, the process 600 further includes an operation of receive at the hub processor a transfer of any of the first output data and/or the second output data from the first image processor and/or the second image processor at block 2202. The hub processor 412 communicates bidirectionally with the image processors 408 and 408N, including receiving image data, binary data, text data, indications, analysis results, synthesized data, or any other output data resultant from processing. The hub processor 412 can then further process received output data prior to transmission to the client 418, including stitching, compression, coding, second order pixel reduction or decimation, object removal, overlapping content removal, color or contrast modifications, file formatting or conversions, or the like.

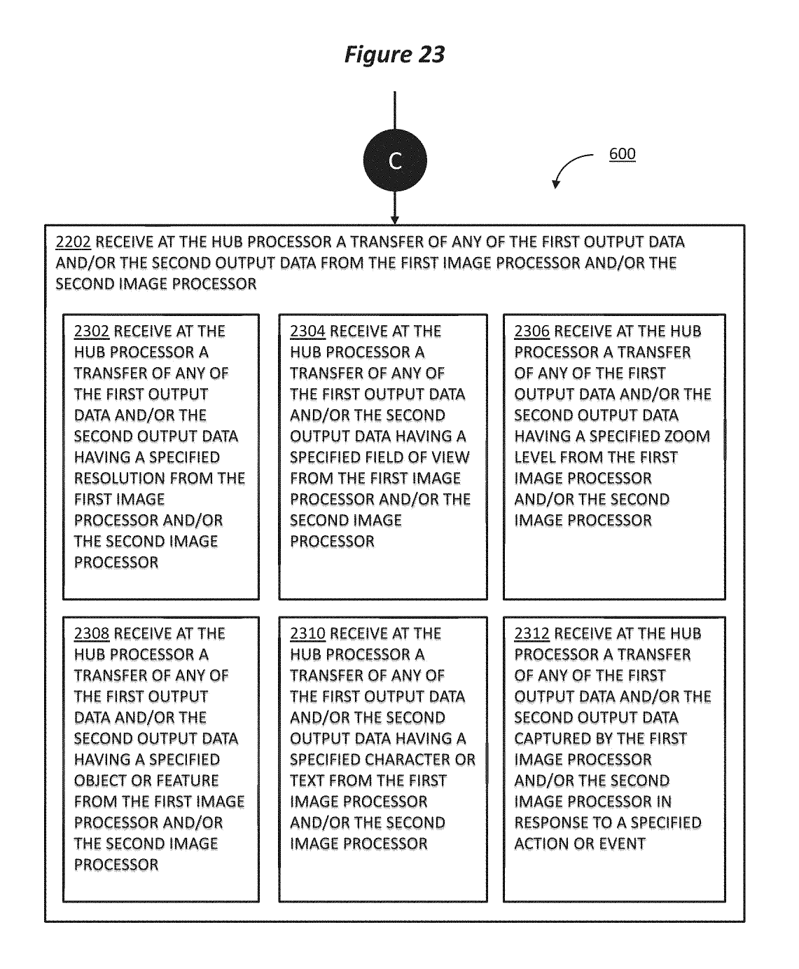

FIG. 23 is a block diagram of a process 600 implemented using an imaging device 400 with edge processing for providing low latency communication of high resolution imagery. In one embodiment, the receive at the hub processor a transfer of any of the first output data and/or the second output data from the first image processor and/or the second image processor at 2202 includes one or more of receive at the hub processor a transfer of any of the first output data and/or the second output data having a specified resolution from the first image processor and/or the second image processor at 2302, receive at the hub processor a transfer of any of the first output data and/or the second output data having a specified field of view from the first image processor and/or the second image processor at 2304, receive at the hub processor a transfer of any of the first output data and/or the second output data having a specified zoom level from the first image processor and/or the second image processor at 2306, receive at the hub processor a transfer of any of the first output data and/or the second output data having a specified object or feature from the first image processor and/or the second image processor at 2308, receive at the hub processor a transfer of any of the first output data and/or the second output data having a specified character or text from the first image processor and/or the second image processor at 2310, or receive at the hub processor a transfer of any of the first output data and/or the second output data captured by the first image processor and/or the second image processor in response to a specified action or event at 2312.

In one embodiment, the hub processor 412 receives a transfer of any of the first output data and/or the second output data having a specified resolution from the first image processor 408 and/or the second image processor 408N at 2302. The first image processor 408 and/or the additional image processor 408N can perform a first order resolution reduction on their respective image data for their respective fields of view. The image data reduced from the first image processor 408 and the image data reduced form the additional image processor 408N can then be received by the hub processor 412, which can perform additional processing. The additional processing of the hub processor 412 can include stitching, compression, coding, formatting, second order image data resolution reduction, or other operation. For example, the hub processor 412 can receive first image data of a first section of a street from a first image processor 408 and second image data of a second section of a street from a second image processor 408N. The first image data and the second image data can be received with 50% resolution reduction. The hub processor 412 can stitch the first image data and the second image data together to generate combined image data associated with the first section of the street and the second section of the street. The hub processor 412 can perform image recognition on the combined image data to determine parking space availability or predicted parking space availability. Upon identifying an available parking space, the hub processor can further process the combined image data to select that image data around the available parking space and further decimate the pixels to reduce the resolution by another 10%. The resultant image data can be compressed and transmitted to the client 418 to assist in locating a parking space.

In one embodiment, the hub processor 412 can receive a transfer of any of the first output data and/or the second output data having a specified field of view from the first image processor 408 and/or the second image processor 408N at 2304. Each of the imaging units 402 and 402N have respective fields of view that differ and may overlap. Within those fields of view, each respective image processor 408 and 408N can select portions that pertain to desirable imagery for a particular request or application. The selected portions or specified fields of view can be received by the hub processor 412. For example, in a border security application, the hub processor can receive selected portions or specified fields of view from two adjacent imaging units 402 and 402N that correspond to detected unauthorized migration of people or vehicles (e.g., a left-most area from one image processor 408 and a right-most area from another image processor 408N). The specified fields of view received can be combined by the hub processor 412 to create a new overall field of view that includes all or portions of each of the received specified fields of view from the image processors 408 and 408N. The hub processor 412 can then output the new overall field of view as video image data for review by border security personnel in real-time or near real-time.

In one embodiment, the hub processor 412 receives a transfer of any of the first output data and/or the second output data having a specified zoom level from the first image processor and/or the second image processor at 2306. The image data received at the hub processor 412 from an image processor 408 can have a specified zoom level established by area and pixel decimation within that area. The zoom level can be further modified by the hub processor 412, such as by increase or decreasing the zoom level by further pixel decimation or by pixel addition. Pixel addition can result in supra-zoom levels with ultra-high visual acuity and can be accomplished by combining pixel data received from multiple image processors 408N. For example, in a context of search and rescue operations, the hub processor 412 can receive first image data from the first image processor 408 with low to no pixel decimation for an area where an injured or lost person is believed to be. The hub processor 412 can receive second image data from an additional image processor 408N that overlaps with the first image data (e.g., the fields of view of the respective optics 404 and 404N overlap). The hub processor 412 can insert pixel data from the second image data into the first image data to enhance the resolution of the area where the injured or lost person is believed to be. This process enables the hub processor 412 to further digitally zoom without further loss of visual acuity to assist in locating and assisting in the rescue of the person.

In one embodiment, the hub processor 412 can receive a transfer of any of the first output data and/or the second output data having a specified object or feature from the first image processor 408 and/or the second image processor 408N at 2308. The hub processor 412 can obtain image data from the image processor 412 that includes a particular specified feature and otherwise not obtain image data to reduce processing load on the hub processor 412. For example, in a context of environmental monitoring, the hub processor 412 can receive image data for a hurricane, wild fire, tornado, tsunami, earthquake, ice calve, or the like at a specified low zoom level with higher pixel decimation. The hub processor 412 can communicate the received image data of the environmental event as real-time or near-real-time video data to the client 418 for review. Alternatively, in a context of home assistance, the hub processor 412 can receive image data from the image processor 408 pertaining to placement of a wallet or purse within a home. The hub processor 412 can store the image data and/or a determined location of the wallet or purse from the image data, which image data or determined location can be retrieved upon subsequent request of the client 418 (e.g., “where is my wallet . . . your wallet is on the kitchen counter behind the grocery bag as depicted in this image”).

In one embodiment, the hub processor 412 can receive a transfer of any of the first output data and/or the second output data having a specified character or text from the first image processor and/or the second image processor at 2310. The hub processor 412 can receive many types of output data from the image processor 408, including alphanumeric text or symbol data. The alphanumeric text or symbol data requires less bandwidth for communication, on the order of bytes per second as opposed to megabytes per second or more for image data. For example, in the context of airplane monitoring and/or airport security, the hub processor 412 can receive from the image processor, tail number (e.g. aircraft registration number) for landing and departing aircraft. The hub processor 412 can use the tail number data to cross-check against flight plans filed that reference the particular airport to identify any unanticipated aircraft traffic. In the event a particular aircraft is unanticipated, the hub processor 412 can request of the image processor 408 image data of the particular aircraft, including increased zoom image data for the pilot and passengers of the aircraft. The hub processor 412 can then notify the client 418 of the unanticipated aircraft using the tail number alone or in combination with supplemental image data associated with the aircraft.

In one embodiment, the hub processor 412 receives a transfer of any of the first output data and/or the second output data captured by the first image processor 408 and/or the second image processor 408N in response to a specified action or event at 2312. Processing load on the hub processor 412 can be reduced by shifting analysis of image data to the image processor 408. When the image processor 408 has detected a particular action or event, the hub processor 412 can receive image data. Otherwise, the hub processor 412 can be made available for other operations. For example, in the application of oil-spill tracking, the image processor 408 can monitor ocean water from space to identify changes in color or absorption indicative of a potential oil spill. Upon detecting the indication of a potential oil spill, the image processor 408 can retain image data through selective pixel retention and pixel decimation and return the image data to the hub processor 412 for further processing. Additional processing may include the hub processor 412 appending the image data to news articles or reporting regarding the oil spill to enable a client 418 to view real-time video of the oil spill in association with one or more news stories about the oil spill.

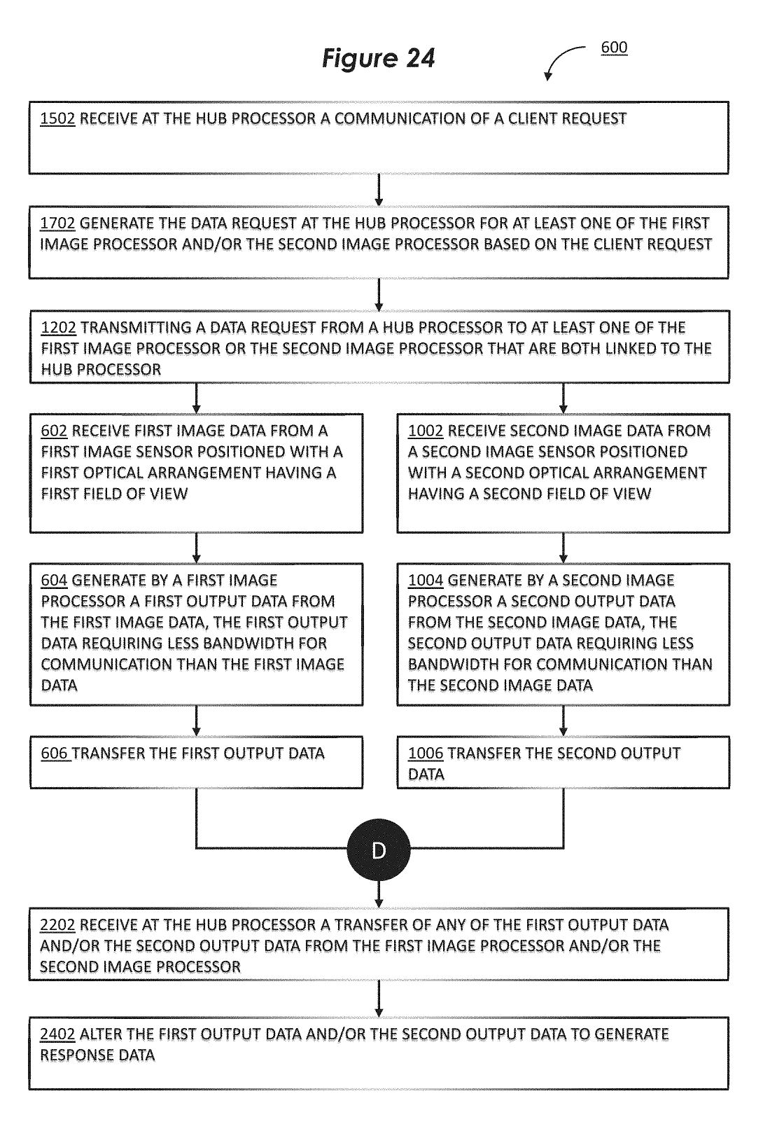

FIG. 24 is a block diagram of a process 600 implemented using an imaging device 400 with edge processing for providing low latency communication of high resolution imagery. In one embodiment, the process 600 further includes the operation of alter the first output data and/or the second output data to generate response data at 2402. The hub processor 412 is not limited necessarily to being a conduit for data to the image processors 408 and 408N. In some embodiments, the hub processor 412 can perform further operations such as, appending metadata, associating image data with search results and/or news articles, compressing, coding, formatting, performing pixel selection or decimation, removing static objects or unchanging imagery, performing object or character recognition, communicating with additional imaging devices 400, aggregating data, performing analysis, generating reports, running 3^{rd} party applications, or the like.

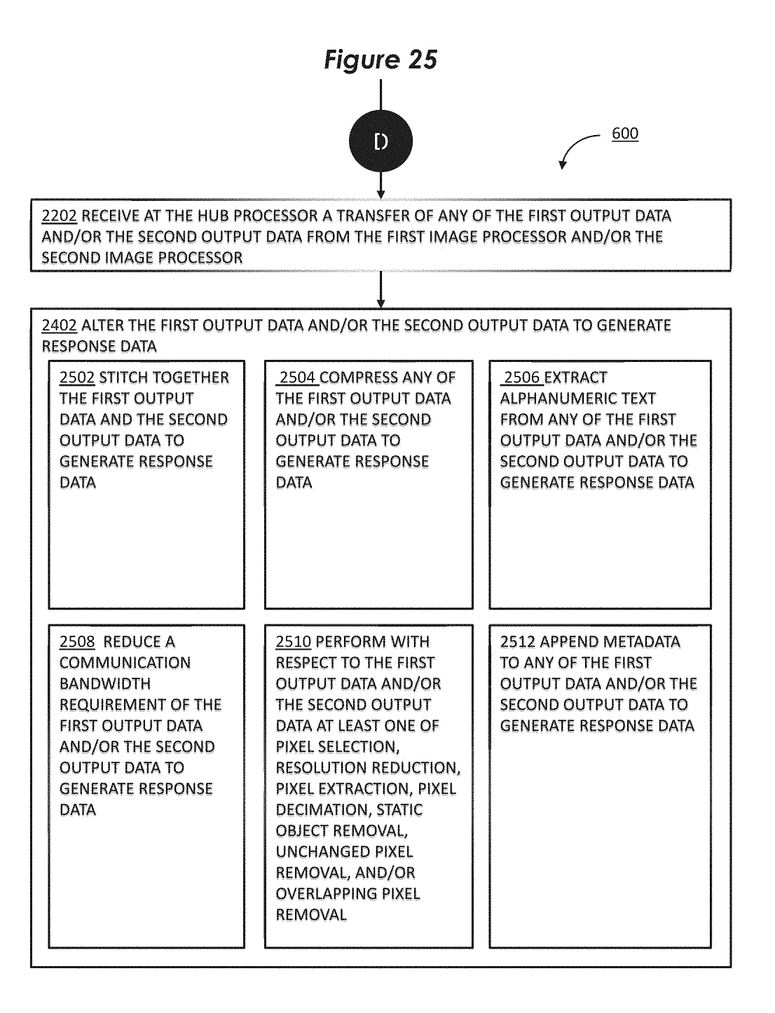

FIG. 25 is a block diagram of a process 600 implemented using an imaging device 400 with edge processing for providing low latency communication of high resolution imagery. In one embodiment, the operation of alter the first output data and/or the second output data to generate response data at 2402 includes one or more of stitch together the first output data and the second output data to generate response data at 2502, compress any of the first output data and/or the second output data to generate response data at 2504, extract alphanumeric text from any of the first output data and/or the second output data to generate response data at 2506, reduce a communication bandwidth requirement of the first output data and/or the second output data to generate response data at 2508, perform with respect to the first output data and/or the second output data at least one of pixel selection, resolution reduction, pixel extraction, pixel decimation, static object removal, unchanged pixel removal, and/or overlapping pixel removal at 2510, or append metadata to any of the first output data and/or the second output data to generate response data at 2512.

In one embodiment, the hub processor 412 stitches together the first output data and the second output data to generate response data at 2502. The hub processor 412 can stitch image data from different image processors 408 and 408N through one or more of image registration, calibration, and/or blending. For instance, the hub processor 412 can align image data from a first image processor 408 and second image processor 408N through coordinates, feature detection, keypoint detection, or another similar methodology. The hub processor 412 can also blend the image data such as through color adjustment or merging to minimize the visibility of seams. For example, in the context of airport security, a person of interest may move between fields of view of one imaging unit 402 and another imaging unit 402N. The hub processor can obtain first video image data from the image processor 408 and second video image data from the image processor 408N associated with the person of interest and stitch the first and second video image data together using overlapping portions for alignment and and blending. The composite video image data resultant from stitching can be transmitted by the hub processor 412 to the client 418 for viewing.

In one embodiment, the hub processor 412 can compress any of the first output data and/or the second output data to generate response data at 2504. The hub processor 412 can use one or more of the following compression techniques to reduce the transmission bandwidth requirement for any image data: reducing color space, chroma subsampling, transform coding, fractal compression, run-length encoding, DPCM, entropy encoding, deflation, chain coding, or the like. Compression is not always necessary and may not be required of the hub processor 412, such as when the output data is text or binary, when bandwidth is available, or when when compression is not desired. For example, in the context of flood monitoring, the hub processor 412 can obtain image data of flood levels and water movement. The hub processor 412 can through compression reduce the bandwidth requirements for transmission of the image data to increase the speed of transmission of the image data to the client 418. The hub processor 412 can then optionally follow up with transmission of uncompressed image data of the flood levels and water movement as needed or requested.

In one embodiment, the hub processor 412 extracts alphanumeric text from any of the first output data and/or the second output data to generate response data at 2506. The hub processor 412 can receive image data from the image processor 408 and perform character recognition with respect to the image data. Recognized text can be used by the hub processor 412 to perform additional operations or the hub processor 412 can transmit the text to the client 418. Additional operations include providing an input to an application program of the hub processor 412, triggering collection of additional image data by the image processor 408, stopping the collection of image data by the image processor 408, adjusting the collection of image data by the image processor 408, or similar operation. For example, in a context of security screening, a hub processor 412 can receive an indication from the image processor 412 that a particular person on a watch-list may have arrived at an airport. The hub processor 412 can then signal the additional image processors 408N and additional imaging devices 400 to monitor the individual for specified behaviors or activities (e.g., leaving a package unattended, nervous high intensity eye or head movements, high blood pressure or pulse rate as determined from skin color changes using eulerian video magnification, perspiration). The hub processor 412 can then obtain image data associated with any specified behaviors or activities to then notify security personal, including a text, binary, coordinate, and/or image based notification.

In one embodiment, the hub processor 412 can reduce a communication bandwidth requirement of the first output data and/or the second output data to generate response data at 2508. The hub processor 412 can perform second order bandwidth reduction operations on image data obtained from the image processor 408. Examples of second order bandwidth reduction operations include pixel decimation, border subtraction, static object removal, encoding, compression, text extraction, overlapping image removal, or the like. The hub processor 412 second order bandwidth reduction operations can be useful, for example, in that overlapping image data of multiple image processors 408 and/or 408N may not be reduced substantially in order to enable stitching. Upon the hub processor 412 completing the stitching, certain portions of the joined areas may be able to be further reduced, such as by removing static objects or performing pixel decimation. For example, in the context of national security, the hub processor 412 can obtain image data from an image processor 408 associated with troop or equipment movement in a hostile area. The hub processor 412 can reduce bandwidth by performing image recognition on the image data to identify location, direction, vehicles, or other similar information. For instance, the hub processor 412 can determine that the troop or equipment movement is associated with a convoy of fifteen armored vehicles traveling on an unpaved road at 45 miles per hour. The hub processor 412 can transmit this data as text to reduce the transmission bandwidth requirement.

In one embodiment, the hub processor 412 performs with respect to the first output data and/or the second output data at least one of pixel selection, resolution reduction, pixel extraction, pixel decimation, static object removal, unchanged pixel removal, and/or overlapping pixel removal at 2510. The hub processor 412 enables low latency, low bandwidth communication of high visual acuity image data of interest through removal of image data that is unimportant, uninteresting, unchanging, or previously transmitted, for example. The hub processor 412 retains and transmits, in certain embodiments, the image data that is of interest at the resolutions that don't exceed that which is possible for viewing on a client device 418. Pixel selection refers to the operation of selecting certain pixels for transmission to the exclusion of others. Resolution reduction refers to the operation of reducing the resolution on a scalable or adjustable basis based on zoom, field of view, client device, user specification, or other similar parameter. The resolution begins at an ultra-high level and can be reduced from that level to otherwise high levels for a particular application. Pixel extraction refers to removal of pixels from image data, such as for storage, transmission during low bandwidth periods, trash, or other similar purpose. Pixel decimation refers to deletion, removal, storage without transmission, or other similar function with respect to one or more portions of image data. Static object removal refers to removal of image data corresponding to a static object that has previously been transmitted and is unchanged. Static object imagery can be gap-filled at a server in the communication link 416 or client device 418 with previously transmitted imagery for the static object. Unchanged pixel removal refers to removal of pixels that have been previously transmitted and are unchanged, which may not relate to a particular object. Overlapping pixel removal refers to satisfying two independent requests for image data that partially overlaps by transmitting the partially overlapping area once, whereby a server in the communication link 416 can use the singly transmitted overlapping area to satisfy the two independent requests.

In one embodiment, the hub processor 412 can append metadata to any of the first output data and/or the second output data to generate response data at 2512. The hub processor 412 can append metadata such as timing, frame rate, location, field of view, resolution, or other parameters associated with the image data for use by the client 418 or server in the communication link 416. Additionally, the hub processor 412 can append metadata such as news articles, internet search results, summary or analysis data, identification information, recommendations, links, social media threads or links, or other similar data to the image data. For example, the hub processor 412 can transmit image data in association with a link to a social media group or in association with access to live comments (FACEBOOK posts or TWITTER feeds) regarding the content of the image data. For instance, in a natural disaster situation, live high acuity visual data of as storm can be transmitted with comments on the storm sourced from a particular FACEBOOK or TWITTER feed to enable access to supplemental information and communication with a population of individuals having similar interests.

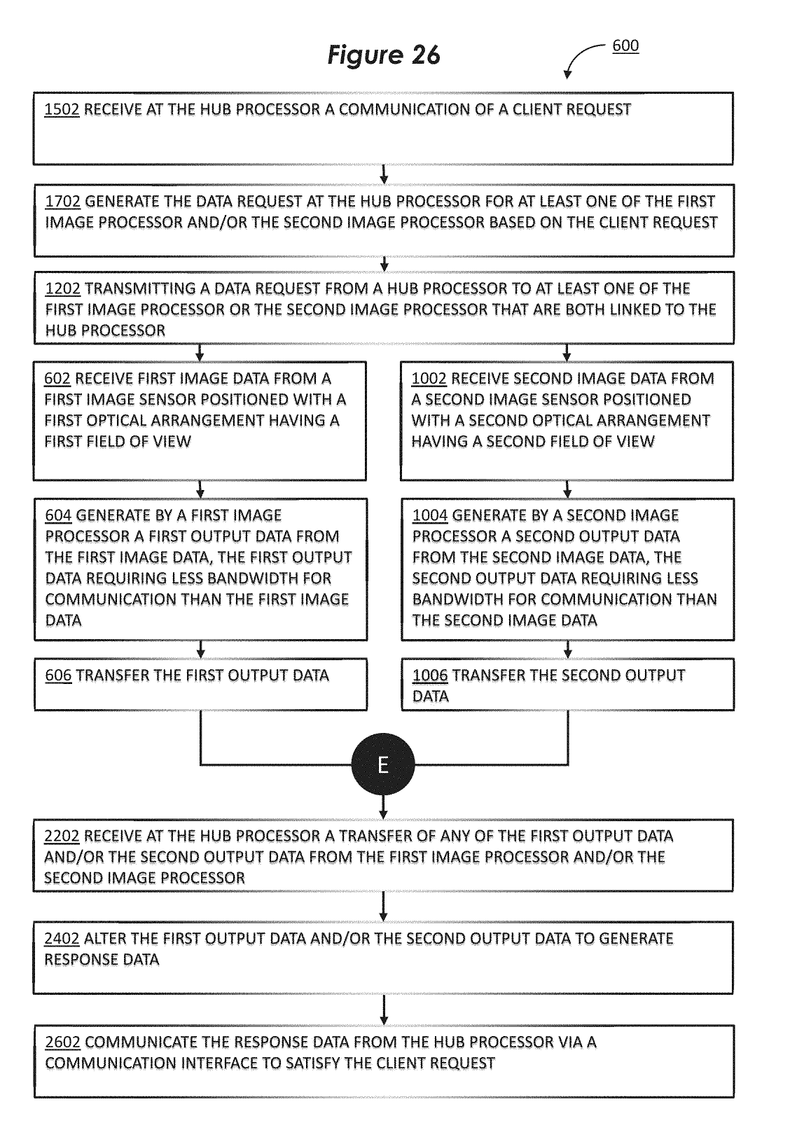

FIG. 26 is a block diagram of a process 600 implemented using an imaging device 400 with edge processing for providing low latency communication of high resolution imagery. In one embodiment, process 600 further includes an operation of communicate the response data from the hub processor via a communication interface to satisfy the client request at 2602. The hub processor 412 can communicate response data via a number of different technologies, including wireless, wire-based, fiberoptic, acoustic, analog, binary, text, or digital form. The imaging device 400 can include the wireless network interface 414 to facilitate the communication and, optionally, can include a plurality of network interfaces of the same or different types. In certain embodiments, the wireless network interface 414 is a link to another communication interface and not necessarily within the same housing of the imaging device 400.

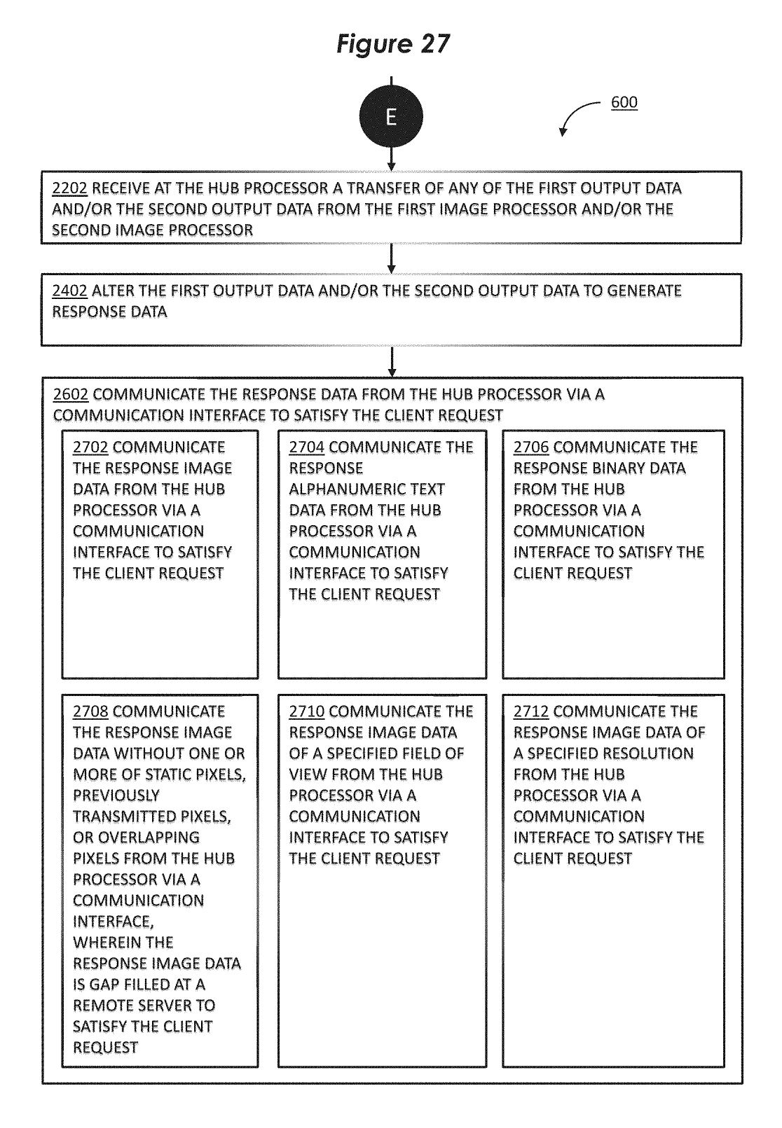

FIG. 27 is a block diagram of a process 600 implemented using an imaging device 400 with edge processing for providing low latency communication of high resolution imagery. In one embodiment, the communicate the response data from the hub processor via a communication interface to satisfy the client request at 2602 includes, but is not limited to communicate the response image data from the hub processor via a communication interface to satisfy the client request at 2702, communicate the response alphanumeric text data from the hub processor via a communication interface to satisfy the client request at 2704, communicate the response binary data from the hub processor via a communication interface to satisfy the client request at 2706, communicate the response image data without one or more of static pixels, previously transmitted pixels, or overlapping pixels from the hub processor via a communication interface, wherein the response image data is gap filled at a remote server to satisfy the client request at 2708, communicate the response image data of a specified field of view from the hub processor via a communication interface to satisfy the client request at 2710, or communicate the response image data of a specified resolution from the hub processor via a communication interface to satisfy the client request at 2712.

In one embodiment, the hub processor 412 communicates the response image data from the hub processor via a communication interface to satisfy the client request at 2702, communicates the response alphanumeric text data via a communication interface to satisfy the client request at 2704, or communicates the response binary data via a communication interface to satisfy the client request at 2706. The hub processor 412 is not limited to transmission of a single type of data or format, but can be programmed to output different data in different formats for different purposes. For instance, the hub processor 412 can be programmed to run an array of applications simultaneously, such as a security monitoring application, an environmental disaster monitoring and reporting application, a ship and fishing tracking application, a treasure hunting application, a news reporting application, an air traffic monitoring application, a gaming application, or a national security application. Each of these applications may call for different outputs, such as text, binary, computer code, image data, video data, summary and analysis reports, or other data. The hub processor 412 can handle these outputs for each application as needed or requested to one or an array of different clients 418. For instance, high zoom high acuity image data can be transmitted for a consumer viewing their neighborhood, at the same time as a binary indication is transmitted for a national security application to a contractor indicating that movement at a particular missile launch site has occurred, at a same time as text information is transmitted for an illegal fishing tracking application of a description of the number of unregistered vessels positioned within a known fishing area.

In one embodiment, the hub processor 412 communicates the response image data without one or more of static pixels, previously transmitted pixels, or overlapping pixels from the hub processor via a communication interface 414, wherein the response image data is gap filled at a remote server to satisfy the client request at 2708. The wireless network interface 414 has relatively low bandwidth capabilities consistent with those available for WIFI, satellite, cellular, or other radio transmission. Moreover, the wireless network interface 414 is a potential bottleneck given that the hub processor 400 can handle configuration by multiple simultaneous applications (e.g., 3^{rd} party application) and multiple simultaneous users. Accordingly, the hub processor 412 and the image processors 408 and 408N can offload some of the image data transmission burden to a server device within the communication link 416 by omitting image data that hasn't changed or has previously been transmitted. The server can then obtain the image data and fill gaps using previously transmitted imagery. As an example, in the mapping context, the hub processor 412 can transmit via the wireless network interface 414 image data for a map including only that image data pertaining to newly constructed roads or buildings. A server having access to the unchanged previously transmitted map image data can update the existing map data with the changed map data of the new roads and buildings prior to providing the updated map data to the client 418. The gap filling can be accomplished for both static imagery as well as video imagery, enabling the client 418 to visualize the most up-to-date map imagery data in real-time or near-real-time with low latency and high acuity.

In one embodiment, the hub processor 412 communicates the response image data of a specified field of view from the hub processor via a communication interface to satisfy the client request at 2710, and/or communicates the response image data of a specified resolution via a communication interface to satisfy the client request at 2712. The hub processor 412 can transmit image data associated with the requested field of view at the requested or specified or default resolution as discussed herein. However, the hub processor 412 can also anticipate fields of view or resolution requests based on parameters such as popularity of a particular object, similarity of an object to another requested object, patterns of requests by others, proximity, a type of application, or other similar parameter. For example, the anticipated fields of view can be transmitted by the hub processor 412 prior to any request for those anticipated fields of view at resolutions that are lower (e.g., through increased pixel decimation) to pre-load image data at the client 418. In this manner, when the client 418 requests image data corresponding to the anticipated fields of view, the hub processor 418 can transmit less data with lower latency, such as previously decimated pixels or changed areas, to satisfy the request. For example, in an asset tracking context, the hub processor 412 may be configured to transmit to the client 418 image data of shipping containers being offloaded from a ship or loaded onto trucks or train cars. The hub processor 412 can identify deviations in the flow of shipping containers and determine that certain portions of the image data are likely to be requested based on those deviations (e.g., movement of a shipping container to an unauthorized area, opening of a shipping container, presence of an individual proximate to the shipping container). The image data associated with those deviations can be transmitted at a lower resolution to the client 418 in anticipation of a subsequent request (e.g., a client 418 asking to view a close-up of a person near a shipping container in a certain area of a shipyard). The hub processor 412 can then follow up to the request with less image data than would be required to satisfy the request due to at least some of the image data being previously transmitted to the client 418.

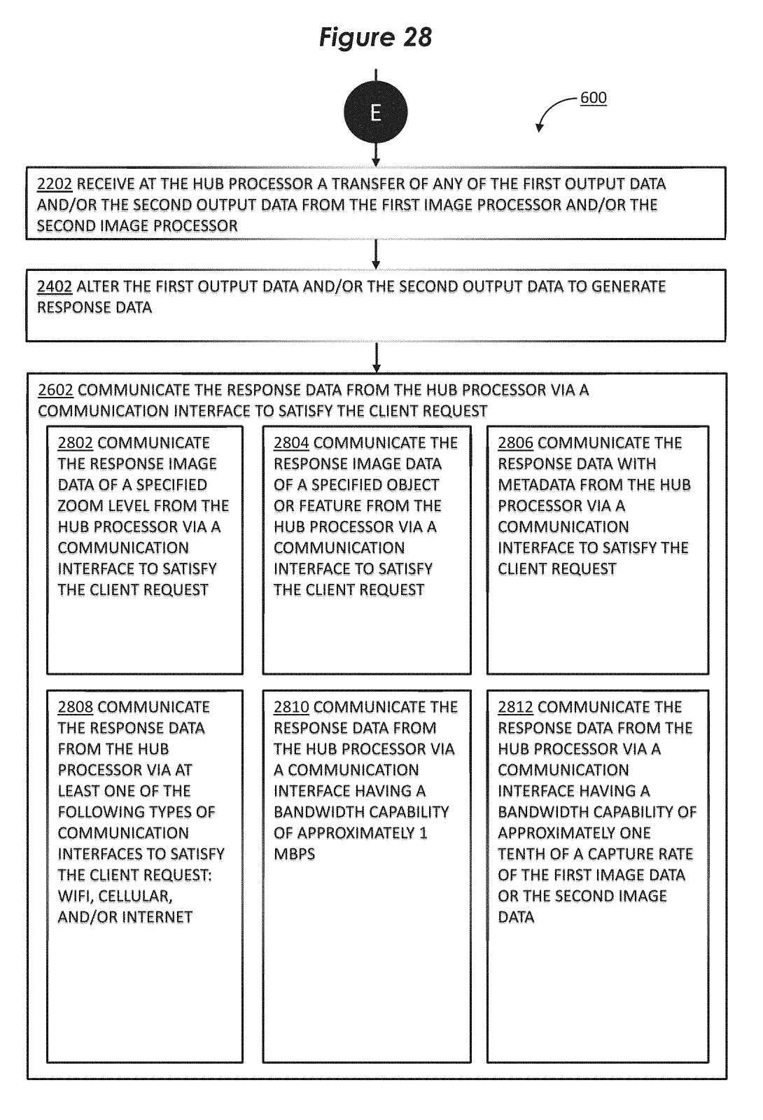

FIG. 28 is a block diagram of a process 600 implemented using an imaging device 400 with edge processing for providing low latency communication of high resolution imagery. In one embodiment, the communicate the response data from the hub processor via a communication interface to satisfy the client request at 2602 includes one or more of communicate the response image data of a specified zoom level from the hub processor via a communication interface to satisfy the client request at 2802, communicate the response image data of a specified object or feature from the hub processor via a communication interface to satisfy the client request at 2804, communicate the response data with metadata from the hub processor via a communication interface to satisfy the client request at 2806, communicate the response data from the hub processor via at least one of the following types of communication interfaces to satisfy the client request: WIFI, satellite, cellular, and/or internet at 2808, communicate the response data from the hub processor via a communication interface having a bandwidth capability of approximately 1 Mbps at 2810, or communicate the response data from the hub processor via a communication interface having a bandwidth capability of approximately one tenth of a capture rate of the first image data or the second image data at 2812.

In one embodiment, the hub processor 412 communicates the response image data of a specified zoom level via a communication interface 414 to satisfy the client request at 2802. The hub processor 412 can transmit image data of a field of view with a specified amount of pixel decimation as discussed herein. However, the hub processor 412 can also anticipate a zoom increase for a particular area and transmit additional pixels for that particular area. In an event the particular area is subject to a zoom increase request, the hub processor 412 can transmit fewer pixels than would otherwise be needed due to at least some of the additional pixels being previously transmitted. For example, in a robocop context where the imaging device 400 is integrated into a movable humanoid, the hub processor 418 can transmit image data having a larger field of view. The hub processor 418 can also detect an event or occurrence within the larger field of view, such as a person having difficulty breathing or walking. Based on this detected occurrence, the hub processor 418 can transmit additional pixel data associated with the person having difficulty breathing (e.g., scale up the pixel data for that particular area within the larger field of view independently of other areas). The amount of pixel data scale up can depend upon user settings, default settings, bandwidth availability, or the like and may be an amount of pixel data that is less than would otherwise be transmitted in response to a user request. In an event that a request for zoom to the person is requested, the hub processor 412 can respond with any additional remaining pixel data to fully satisfy the request. The targeted irregular pixel density transmitted by the hub processor 412 can therefore help reduce latency of future requests.

In one embodiment, the hub processor 412 can communicate the response image data of a specified object or feature via a communication interface 414 to satisfy the client request at 2804. As discussed herein, the hub processor 412 can transmit image data for a particular object or feature as requested. However, the hub processor 412 can also transmit unrequested image data associated with certain objects or features in anticipation of future requests for image data of the objects of features. The determination as to which objects or features are important enough to transmit may be determined by the hub processor based on one or more factors, such as similarity to other requested objects, popularity of an object, uniqueness of a feature, movement of an object, color of an object, or other parameter. For instance, in the consumer analytics context, the hub processor 412 can recognize facial expressions indicative of disapproval or other negative emotions. In response to recognition of such instances, the hub processor can send data analytics to the client 418 (e.g., checkout person A was associated with negative emotions in 75% of checkout customers). In anticipation of a request for image data associated with the checkout line of person A, the hub processor 412 can preload imagery to a server or the client 418 of the relevant interactions to enable lower latency response to subsequent requests for the image data.

In one embodiment, the hub processor 412 communicates the response data with metadata via a communication interface to satisfy the client request at 2806. Metadata can include any information supplemental to, based upon, or derived from the image data. The metadata can include image data, text, binary, computer program instructions, audio, links, information regarding the image data, or content, such as social media, news, videos, articles, etc. The metadata can be used by the client 418 or by another intermediate device on the communication link 416. Additionally, the metadata can be added to transmitted image data from the hub processor 412 by another intermediate device on the communication link 416, such as a server.

In one embodiment, the hub processor 412 communicates the response data via at least one of the following types of communication interfaces to satisfy the client request: WIFI, satellite, cellular, and/or internet at 2808, communicates the response data via a communication interface having a bandwidth capability of approximately 1 Mbps at 2810, and/or communicates the response data a communication interface having a bandwidth capability of approximately one tenth of a capture rate of the first image data or the second image data at 2812. The communication interface 414 can be wireless or wire-based, but is nonetheless limited in its ability to transmit all of the image data collected by each of the imaging units 402 and 402N at any given time. The raw image data collected by each of the imaging units 402 can be on the order of multitudes of gigabytes per second or more as compared to communication bandwidth availability that may be as low as a few megabytes per second. This bandwidth constraint can be eliminated or minimized as discussed herein by processing collected image data at the edge or at the image processor 408 and hub processor 412 level prior to transmission. When image data is transmitted, it can be the image data needed at high resolutions with high visual acuity. Unrequested or unneeded image data can be omitted, decimated, held, stored, transmitted at lower resolutions, or transmitted off-peak, for example. Furthermore, applications operating at the edge or at the level of the imaging device 400 can process raw image data prior to any transmission, thereby generating binary, text, computer code, or other non-image data for transmission in lieu of image data.

The present disclosure may have additional embodiments, may be practiced without one or more of the details described for any particular described embodiment, or may have any detail described for one particular embodiment practiced with any other detail described for another embodiment. Furthermore, while certain embodiments have been illustrated and described, as noted above, many changes can be made without departing from the spirit and scope of the disclosure.

1. A device for providing low latency communication of high resolution imagery, the device comprising:
a first imaging unit including at least:
a first optical arrangement directed at a first field of view;
a first image sensor that is positioned with the first optical arrangement and that is configured to convert detected light into first image data; and
a first image processor coupled to the first image sensor and configured to execute operations including at least:
receive the first image data;
process the first image data to generate first output data that requires less bandwidth for communication than the first image data; and
transfer the first output data.

2-13. (canceled)

14. The device of claim 1, further comprising:
a second imaging unit including at least:
a second optical arrangement directed at a second field of view;
a second image sensor that is positioned with the second optical arrangement and that is configured to convert detected light into second image data;
a second image processor coupled to the second image sensor and configured to execute operations including at least:
receive the second image data;
process the second image data to generate second output data that requires less bandwidth for communication than the second image data; and
transfer the second output data.

15. (canceled)

16. The device of claim 14, wherein the first field of view and the second field of view at least partially overlap.

17-18. (canceled)

19. The device of claim 14, wherein the first imaging unit and the second imaging unit enable capture of the first image data and the second image data at different resolutions.

20-21. (canceled)

22. The device of claim 14, further comprising:
a communication interface;
a hub processor coupled to the communication interface; and
a hub circuit linking the first image processor and the second image processor with the hub processor.

23. The device of claim 22, wherein the hub processor coupled to the communication interface comprises:
a hub processor having one or more ports for removably coupling one or more imaging units to expand a field of view of the device.

24-29. (canceled)

30. The device of claim 22, wherein the first image processor is further configured to execute an operation comprising:
receive a data request from the hub processor,
wherein the process the first image data to generate first output data that requires less bandwidth for communication than the first image data includes, but is not limited to, process the first image data to generate first output data that requires less bandwidth for communication than the first image data, based on the data request received from the hub processor.

31. The device of claim 30, wherein the process the first image data to generate first output data that requires less bandwidth for communication than the first image data, based on the data request received from the hub processor comprises:
process the first image data to generate first output image data by decimating one or more pixels within a field of view selected based on the data request received from the hub processor to maintain a constant resolution independent of a zoom level.

32. The device of claim 30, wherein the process the first image data to generate first output data that requires less bandwidth for communication than the first image data, based on the data request received from the hub processor comprises:
process the first image data to generate first output image data by decimating one or more pixels within a field of view selected based on the data request received from the hub processor to maintain a resolution independent of a zoom level that is less than or equal to a resolution of a client device.

33. (canceled)

34. The device of claim 30, wherein the process the first image data to generate first output data that requires less bandwidth for communication than the first image data, based on the data request received from the hub processor comprises:
process the first image data to generate first output data that requires less bandwidth for communication than the first image data, based on the data request received from the hub processor and based on object or feature recognition.

35. The device of claim 30, wherein the process the first image data to generate first output data that requires less bandwidth for communication than the first image data, based on the data request received from the hub processor comprises:
process the first image data to generate first output data that requires less bandwidth for communication than the first image data, based on the data request received from the hub processor and based on character recognition.

36. The device of claim 30, wherein the process the first image data to generate first output data that requires less bandwidth for communication than the first image data, based on the data request received from the hub processor comprises:
process the first image data to generate first output data that requires less bandwidth for communication than the first image data, based on the data request received from the hub processor and based on action or event recognition.

37. The device of claim 30, wherein the process the first image data to generate first output data that requires less bandwidth for communication than the first image data, based on the data request received from the hub processor comprises:
process the first image data to generate first output image data of a specified resolution, based on the data request received from the hub processor.

38. The device of claim 30, wherein the process the first image data to generate first output data that requires less bandwidth for communication than the first image data, based on the data request received from the hub processor comprises:
process the first image data to generate first output image data of a specified field of view, based on the data request received from the hub processor.

39. The device of claim 30, wherein the process the first image data to generate first output data that requires less bandwidth for communication than the first image data, based on the data request received from the hub processor comprises:
process the first image data to generate first output image data of a specified zoom-level, based on the data request received from the hub processor.

40. The device of claim 30, wherein the process the first image data to generate first output data that requires less bandwidth for communication than the first image data, based on the data request received from the hub processor comprises:
process the first image data to generate first output image data of a specified object or feature, based on the data request received from the hub processor.

41. (canceled)

42. The device of claim 30, wherein the process the first image data to generate first output data that requires less bandwidth for communication than the first image data, based on the data request received from the hub processor comprises:
process the first image data to generate first output image data in response to detection of a specified action or event, based on the data request received from the hub processor.

43. The device of claim 30, wherein the process the first image data to generate first output data that requires less bandwidth for communication than the first image data, based on the data request received from the hub processor comprises:
process the first image data to generate first output data as alphanumeric text extracted from the first image data, based on the data request received from the hub processor.

44-53. (canceled)

54. The device of claim 22, wherein the hub processor is configured to execute an operation comprising:
generate a data request for at least one of the first image processor and/or the second image processor based on a program request of an application hosted on the hub processor.

55. The device of claim 22, wherein the hub processor is configured to execute an operation comprising:
generate a first data request for the first image processor a second data request for the second image processor based on a client request received via the communication interface based on an ability of the first image processor and the second image processor to satisfy the client request.

56-61. (canceled)

62. The device of claim 22, wherein the hub processor is configured to execute an operation comprising:
select at least one of the first image processor and/or the second image processor based on ability to satisfy a client request.

63. The device of claim 22, wherein the hub processor is configured to execute an operation comprising:
at least one of coordinate, triage, delegate, and/or manage data requests with at least one of the first image processor and/or the second image processor based on ability to satisfy a client request.

64-65. (canceled)

66. The device of claim 22, wherein the hub processor is configured to execute an operation comprising:
distribute processing load to the first image processor and/or the second image processor based on ability to satisfy a client request.

67-68. (canceled)

69. The device of claim 22, wherein the hub processor is configured to execute an operation comprising:
receive via the hub circuit a transfer of any of the first output data and/or the second output data from the first image processor and/or the second image processor.

70. The device of claim 22, wherein the hub processor is configured to execute an operation comprising:
receive via the hub circuit a transfer of the first output data as first image output data and the second output data as second image output data from the first image processor and the second image processor; and
stitch together the first image output data and the second image output data.

71. (canceled)

72. The device of claim 22, wherein the hub processor is configured to execute an operation comprising:
receive via the hub circuit a transfer of the first output data as first image output data and/or the second output data as second image output data from the first image processor and/or the second image processor; and
extract alphanumeric text from the first image output data and/or the second image output data.

73-79. (canceled)

80. The device of claim 22, wherein the hub processor is configured to execute an operation comprising:
process any of the first output data and/or the second output data received from the first image processor and/or the second image processor to further reduce a bandwidth requirement for communication via the communication interface.

81. (canceled)

82. The device of claim 22, wherein the hub processor is configured to execute an operation comprising:
append metadata to any of the first output data and/or the second output data received from the first image processor and/or the second image processor.

83-94. (canceled)

95. The device of claim 22, wherein the hub processor is configured to execute an operation comprising:
receive an upload of a third party application via the communication interface;
execute the third party application; and
perform one or more custom operations based on execution of the third party application.

96-181. (canceled)
